(19) United States
(12) Patent Application Publication
(10) Pub. No.: US 2002/0099638 A1
(43) Pub. Date: Jul. 25, 2002

(54) Method and system for electronically communicating with suppliers, such as under an electronic auction

(76) Inventors: Kathryn D. Coffman, Greer, SC (US); Paula J. Duell, Austell, GA (US); Vincio B. Tiburcio, Kennesaw, GA (US)

Correspondence Address: PERKINS COIE LLP, PATENT-SEA, P.O. BOX 1247, SEATTLE, WA, 98111-1247, US

(21) Appl. No.: 09/754,027

(22) Filed: Jan. 3, 2001

(51) Int. Cl. G06F 17/60

(52) U.S. Cl. 705/37

(57) ABSTRACT

Disclosed is a system for listing, approving and contacting suppliers or other individuals/organizations. In one embodiment, a user schedules an electronic auction and then selects suppliers from a list of suppliers to participate in the auction. New suppliers may be added. The system provides a series of Web page forms or other user input devices for receiving supplier selection and new supplier data. Other authorized users may either make suggestions and/or approve suppliers. The system provides automatic notification between such users and provides directly, or gives access to, electronic documents providing relevant information, such as information regarding the auction. Once all suppliers have been accepted, the system automatically distributes relevant information to accepted suppliers.

### TECHNICAL FIELD

The disclosure relates generally to electronic commerce.

### BACKGROUND AND SUMMARY

Many businesses, particularly those in the manufacturing industries, wish to obtain raw materials and parts at the lowest possible price, while ensuring quality, timely delivery and other factors important to the business. The requisitioning process for procuring materials or goods has often been a labor-intensive, inefficient and nonstandardized process. In general, a buyer must first decide what he or she will buy; second, identify sources for the items to be purchased; and third, identify what must be performed to qualify a source or item supplied by the sources.

FIGS. 1A and 1B show an example of a typical requisitioning process 100. Beginning in block 102, a buyer identifies something that needs to be purchased and when it must be delivered. In block 104, the buyer determines whether a purchasing contract is in place for the item. If so, then in block 106, the existing purchasing contract is employed. If not, then in block 108, the buyer identifies one or more suppliers capable of supplying the item. In block 110, if the buyer is not approved, then in block 112, the buyer must be preapproved, such as by executing a secrecy agreement.

In addition to identifying suppliers, the buyer must prepare an RFQ. An RFQ, or “Request For Quotations,” contains information suppliers need to prepare a bid or quotation. The RFQ likely also includes information or details regarding aspects of the item to be purchased that are important or critical to the buyer. (While RFQs are described herein, the following description applies equally to requests for proposals (“RFPs”) and related documents generated by one party and distributed to multiple parties to obtain a preferred or best response (in the eyes of the preparer) under a generally competitive process.) Typically, the RFQ is not reviewed for completeness, and is often used only for domestic suppliers. Thus, certain additional information is not required, such as export control licenses and the like. The identified suppliers (previously approved, or approved under block 112) receive the RFQ, such as by mail or email, under block 116. In block 118, the business receives technical proposals and proposed deviations or exceptions to the RFQ from one or more suppliers. The buyer or other evaluator can determine whether the product or item proposed by a supplier is acceptable for the buyer's intended application. If not, the supplier may not be permitted to participate.

In block 120, bids begin to trickle in from the suppliers. All bids are considered received by some cutoff point, under block 122. In block 124, the buyer negotiates with one or more suppliers based on the received bids, and in block 126 determines a supplier from whom to purchase the desired item. In block 128, the buyer provides oral or written feedback to the suppliers identifying, for example, the supplier selected and possible reasons for the selection.

Under block 130, if the item purchased requires qualification, then in block 132, a qualification plan is defined by either the buyer, a quality assurance individual or some other person. In block 134, the buyer or other individual requests samples from the supplier in order to execute the qualification plan. In block 136, the qualification plan is executed and the purchased items are tested. If the items do not qualify under block 138, then in block 140, it is determined whether time exists to retest the items. If so, the process loops back to block 136, and if not, the buyer may renegotiate with the supplier or one or more other qualified suppliers, under block 142. If the samples passed qualification testing, and the vendor does not have a vendor number under block 144, the buyer or other individual obtain a supplier or vendor number in block 146. Following blocks 130, 142, 144 or 146, “Material Requisition Planning” (“MRP”) or purchasing system data is updated, such as to include a vendor number under block 148. In block 150, the MRP system automatically generates one or more purchase orders to purchase the required items.

An MRP system is a system by which purchasing contracts are planned based on the need date of the purchased item. For “direct material” (i.e., purchased material that is incorporated directly into a product to be sold), the MRP system employs or calculates a quantity of an item required based on sales that incorporate that purchased item. For “indirect material” (i.e., purchased material that is consumed rather than converted into a sold product), the MRP system employs or calculates the appropriate reorder time/amount based on stock on hand and consumption rate. The MRP system contains complete supplier and product information, such as the most recent quotes, preferred vendor identification and the like. MRP systems are well-known in the art, and employ automated software tools to perform such processes, automatically generating purchase orders as required to purchase items the system forecasts will be needed by the anticipated delivery date of such items.

There are many bottlenecks in the process described above. Examples of such bottlenecks are indicated by ovals within FIGS. 1A and 1B. One significant bottleneck involves identifying, evaluating, communicating with or inviting suppliers to participate in an auction. Prior methods for identifying and contacting suppliers involved generating a list, often via spreadsheet, showing contact information and other data with respect to suppliers or potential suppliers, and then having an individual contact the supplier (such as by electronic mail) to insure that all information and documentation was transferred successfully to a supplier before the auction. Considerable time was spent by an individual initiating the auction (an “auction owner”) such as typing in supplier contact information, verifying the information and contacting suppliers. To free up the auction owner's time, administrative support personnel within the organization were given the task of contacting suppliers and ensuring information exchange. Nevertheless, the process required many manual steps and was time consuming.

Another problem with prior requisitioning systems was that they typically were inefficient at managing high-volume activities, incapable of handling high-speed negotiations, incapable of purchasing foreign-manufactured goods, unable to leverage across business units, ineffective with communications and transactions, fraught with time zone problems and/or other problems. For example, an RFQ may have been provided to suppliers without providing the suppliers with corresponding adequate preparation time. In general, bottlenecks occur in generating and distributing the RFQ (e.g., gathering and including drawings and pictures, identifying leveraging opportunities), obtaining vendor numbers, updating MRP or purchasing systems, etc.

As noted above, prior art attempts to automate the requisitioning process included using email. However, email often has limitations in sending large electronic documents. Further, many steps in the process described above are manual. The inventors have found that using a public computer network, such as the Internet, may be employed to improve efficiency.

The Internet is increasingly being used to conduct “electronic commerce.” The Internet comprises a vast number of computers and computer networks interconnected through communications channels. Electronic commerce generally refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction.

The World Wide Web portion of the Internet is especially conducive to conducting electronic commerce. Many Web servers have been developed through which vendors can sell items. Generally, an “item” is any product, service, or exchangeable entity of any type. A server computer system may provide an electronic version of a catalog that lists the items that are available. A user, who is a potential purchaser, may browse through the catalog using a browser and select various items to be purchased. When the user has completed selecting the items to be purchased, the server computer system then prompts the user for information to complete the ordering of the items. This purchaser-specific order information may include the purchaser's name, the purchaser's credit card number and a shipping address for the order. The server computer system then typically confirms the order by sending a confirming Web page to the client computer system and schedules shipment of the items.

The World Wide Web is also being used to conduct other types of commercial transactions. For example, some server computer systems have been developed to support the conducting of auctions electronically. To conduct an auction electronically, the seller of an item provides a definition of the auction via Web pages to a server computer system. The definition includes a description of the item, an auction time period and optionally, a minimum bid. The server computer system then conducts the auction during the specified time period. Potential buyers can search the server computer system for an auction of interest. When such an auction is found, the potential buyer can view the bidding history for the auction and enter a bid for the item. When the auction is closed, the server computer system notifies the winning bidder and the seller (e.g., via electronic mail) so that they can complete the transaction.

A reverse auction may be preferred for procurement. A “reverse auction” is one in which the purchaser states requirements; then, suppliers who can meet the stated requirements compete for the business by offering the lowest price, quickest delivery, or whatever other conditions are sought by the purchaser. It is “reverse” because the usual competitive factor is price, and unlike a typical auction (“forward auction”), price goes down as the auction progresses.

Described in detail below is a method and system to list suppliers, qualify suppliers and distribute required documents to suppliers. The system employs modules that provide some or all of the following functionality: supplier list functionality, supplier qualification functionality and distribution functionality.

### BRIEF DESCRIPTION OF THE DRAWINGS

FIGS. 1A and 1B together form a flow diagram illustrating an example of a prior art procurement process.

FIG. 2 shows a home page computer screen, with a hypertext link for accessing a depicted Create New Auction Web page screen.

FIG. 3 is an example of a Web page screen acknowledging creation of an RFQ, with a hypertext link for accessing one or more screens to add suppliers.

FIG. 4 is an example of a Web page screen for adding suppliers to an auction.

FIG. 5 a Web page screen depicting a supplier search.

FIG. 6 is an example of a Web page screen for identifying a contact for a selected supplier.

FIG. 7 is a top portion of a Web page screen that is an alternative Web page screen to that of FIG. 4.

FIG. 8 shows the Web page screen of FIG. 7 with a pull-down menu listing Asian countries.

FIG. 9 is an example of a Web page screen forming a bottom portion of the screens of FIGS. 7 and 8.

FIG. 10 is an example of a Web page screen for identifying a supplier by name.

FIG. 11 shows the Web page screen of FIG. 10 with a pull-down menu listing suppliers.

FIG. 12 shows the Web page screen of FIG. 7 with a supplier selected from the pull-down menu of FIG. 11.

FIG. 13 is an example of a Web page screen for searching for suppliers from a supplier list.

FIG. 14 is an example of a Web page screen listing suggested suppliers to participate in a scheduled auction.

FIG. 15 is a Web page screen showing an alternative to the screen of FIG. 14.

FIG. 16 is a Web page screen for purchase order placement and tracking (which may be completed before or after an auction).

FIG. 17 is a block diagram illustrating a suitable hardware environment for implementing aspects of the invention.

FIG. 18 is a flow diagram illustrating an example of a supplier listing, approving and contacting method.

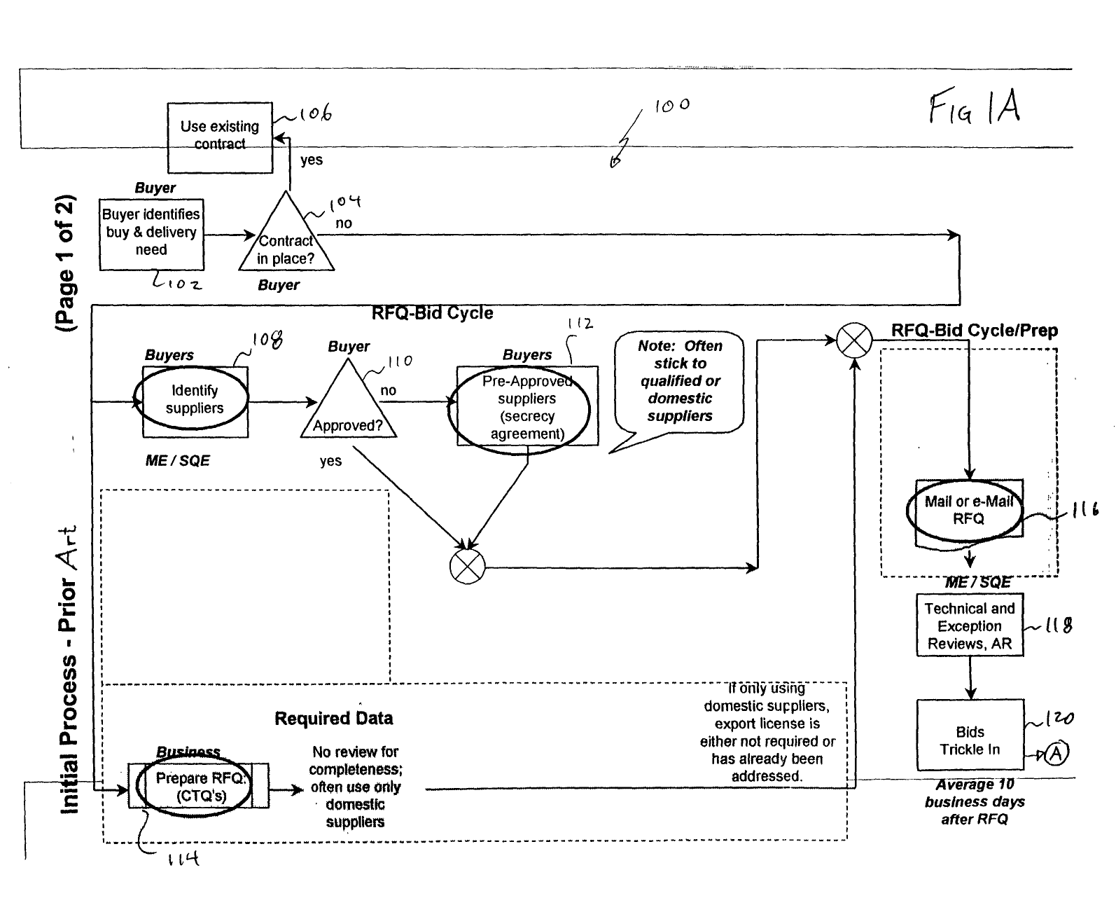

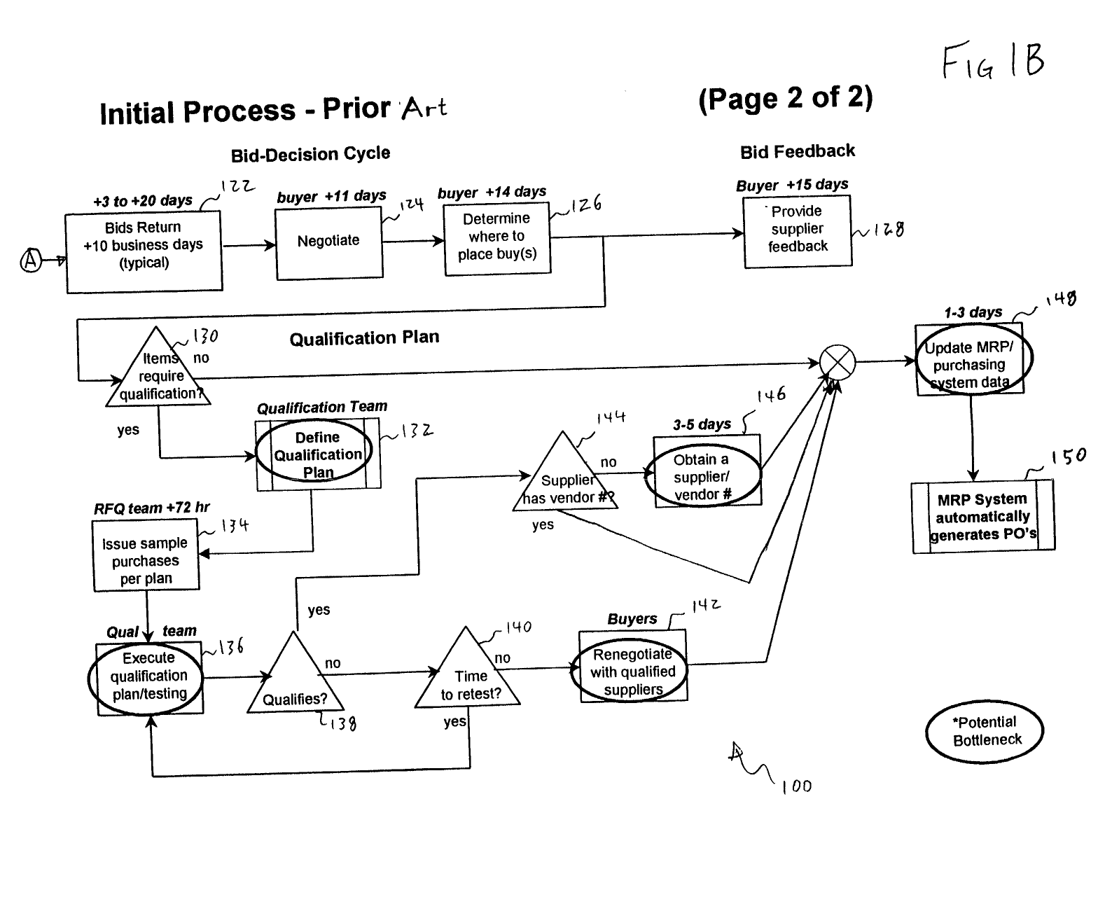

In the drawings, identical reference numbers identify identical or substantially similar elements or acts. To easily identify the discussion of any particular element or act, the most significant digit or digits in a reference number refer to the Figure number in which that element is first introduced (e.g., block 1802 is first introduced and discussed with respect to FIG. 18).

The headings provided herein are for convenience only, and do not affect the scope or meaning of the claimed invention.

### DETAILED DESCRIPTION

A process for listing, approving and contacting suppliers or other individuals/organizations, such as for use in electronic auctions, is described in detail below. In the following description, numerous specific details are provided, such as specific data fields and forms, ordering of processes, necessary input fields and the like, to provide a thorough understanding of, and enabling description for, embodiments of the invention. One skilled in the relevant art, however, will recognize that the invention can be practiced without one or more of the specific details, or with other fields, forms or processes, etc. In other instances, well-known structures or operations are not shown or described in detail to avoid obscuring aspects of the invention.

In general, the process and system described in detail herein provides a computer network-based tool that enables buyers or other individuals to rapidly add suppliers to a list of those invited to participate in an auction, such as an electronic auction. The process includes identifying suppliers (such as new international global suppliers), preapproving such suppliers (such as ensuring intellectual property is protected and business audits are conducted) and assessing the supplier's liability. The process may search and retrieve suppliers from existing databases (such as purchasing system or previous electronic auction participants databases), thereby saving time in identifying and populating required fields in forms for such suppliers. New suppliers, however, may be added at any time. The supplier list is linked to an electronic distribution tool to automatically communicate all auction documentation (e.g., RFQs, meeting notices, technical review information, etc.) to suppliers proposed or approved to participate in the auction.

The system provides a Web-based electronic tool to simplify and accelerate the process of listing potential suppliers for electronic auctions, verifying their pre-approval to participate and communicating auction information to them electronically. The tool fulfills at least one or more of the following criteria: encompassing existing international standards organization (“ISO”) procedures of business units within the organization; obtaining approval of the auction owner for a supplier to participate, thus insuring successful suppliers could expect to receive procurement contracts; requiring approval of pole personnel that a self-assessment by a supplier (“white paper”) was sufficiently complete to permit a supplier to participate in an auction; requiring approval of a quality monitor that secrecy/intellectual property protection agreements were executed by suppliers and on file to prevent the supplier to participate in an auction; requiring auction owners to list and approve potential suppliers for participating in upcoming options; capability to measure potential success and improvement (e.g., cycle time reduction and variation control); restricting access to certain fields relating to supplier approval status to certain individuals within the organization; enabling or denying an electronic distribution of auction documents to suppliers based on approval status; and sending information or notifying e-mails to both auction support personnel and suppliers.

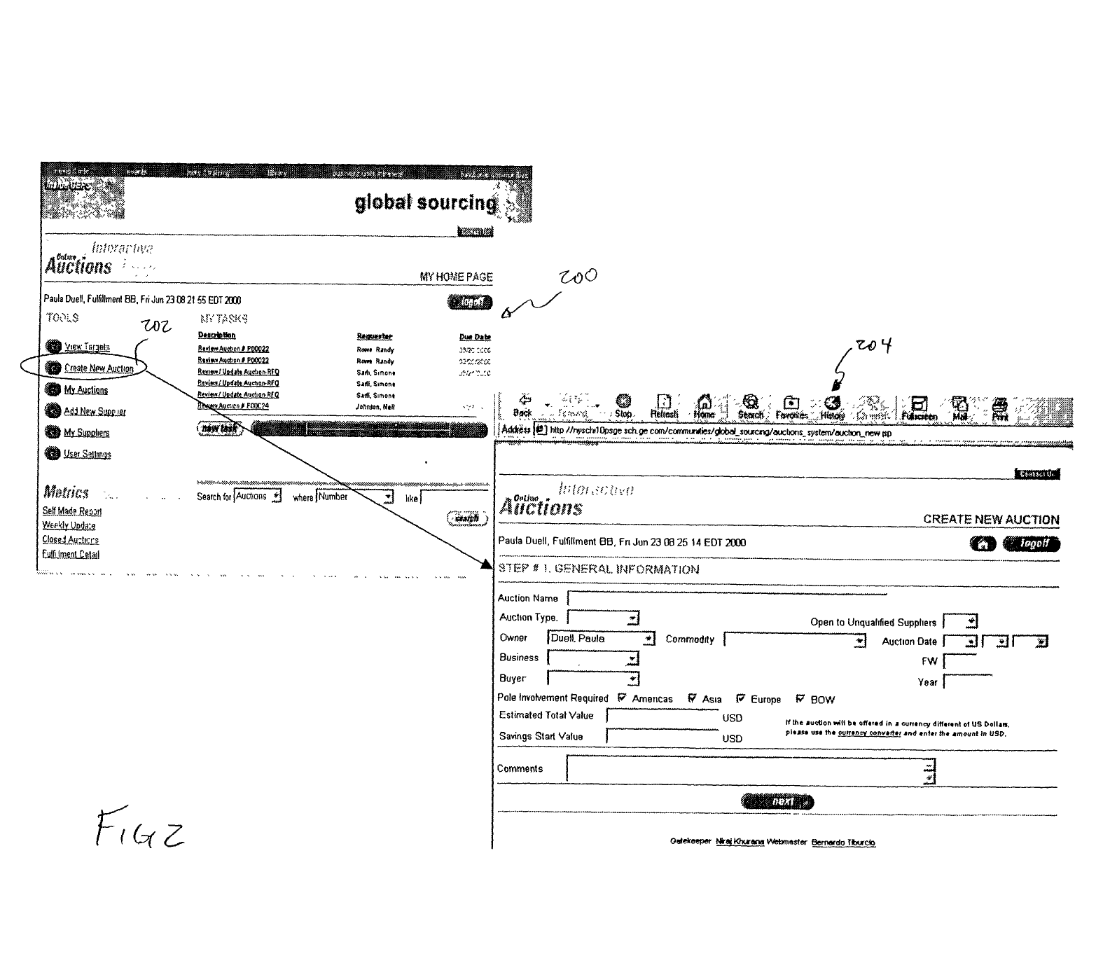

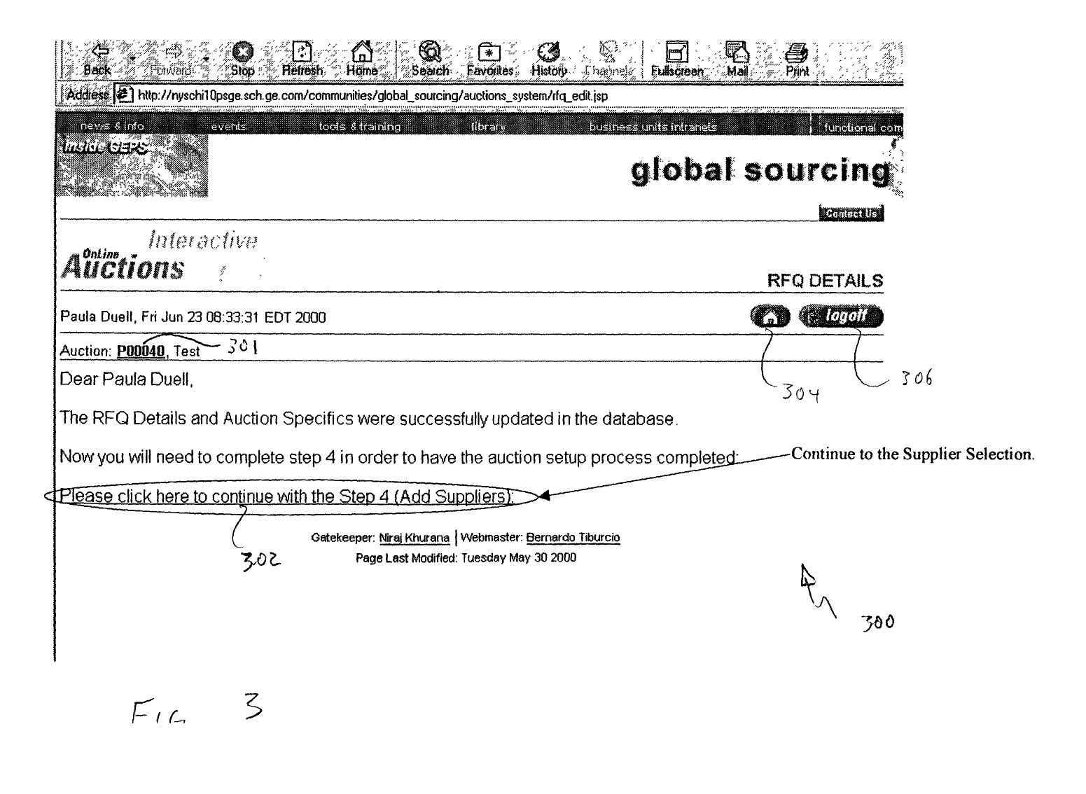

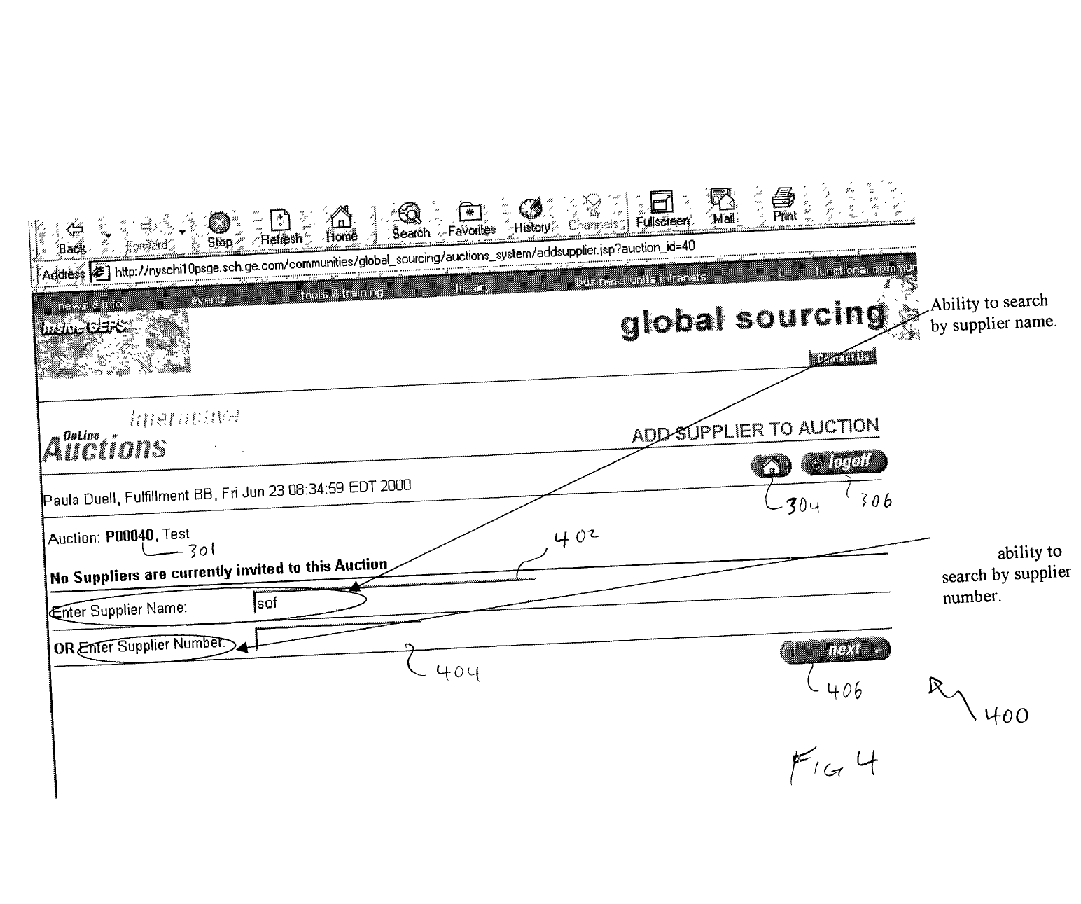

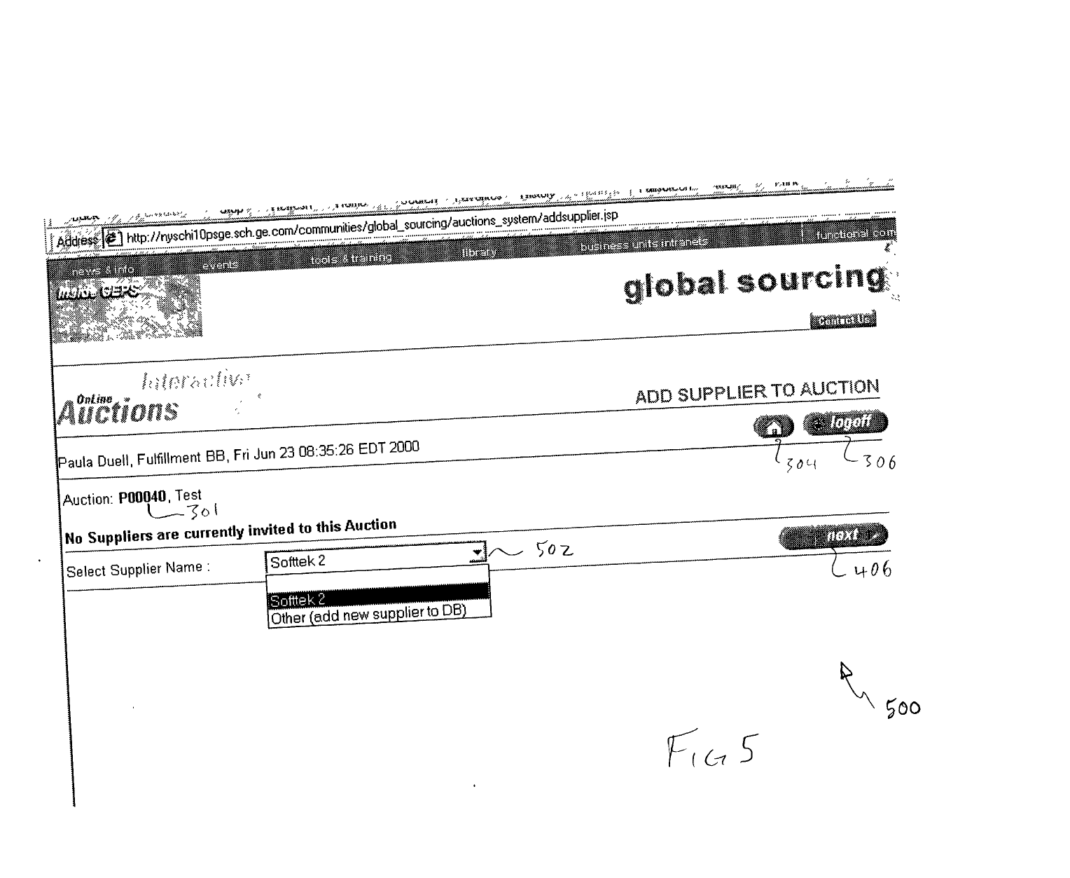

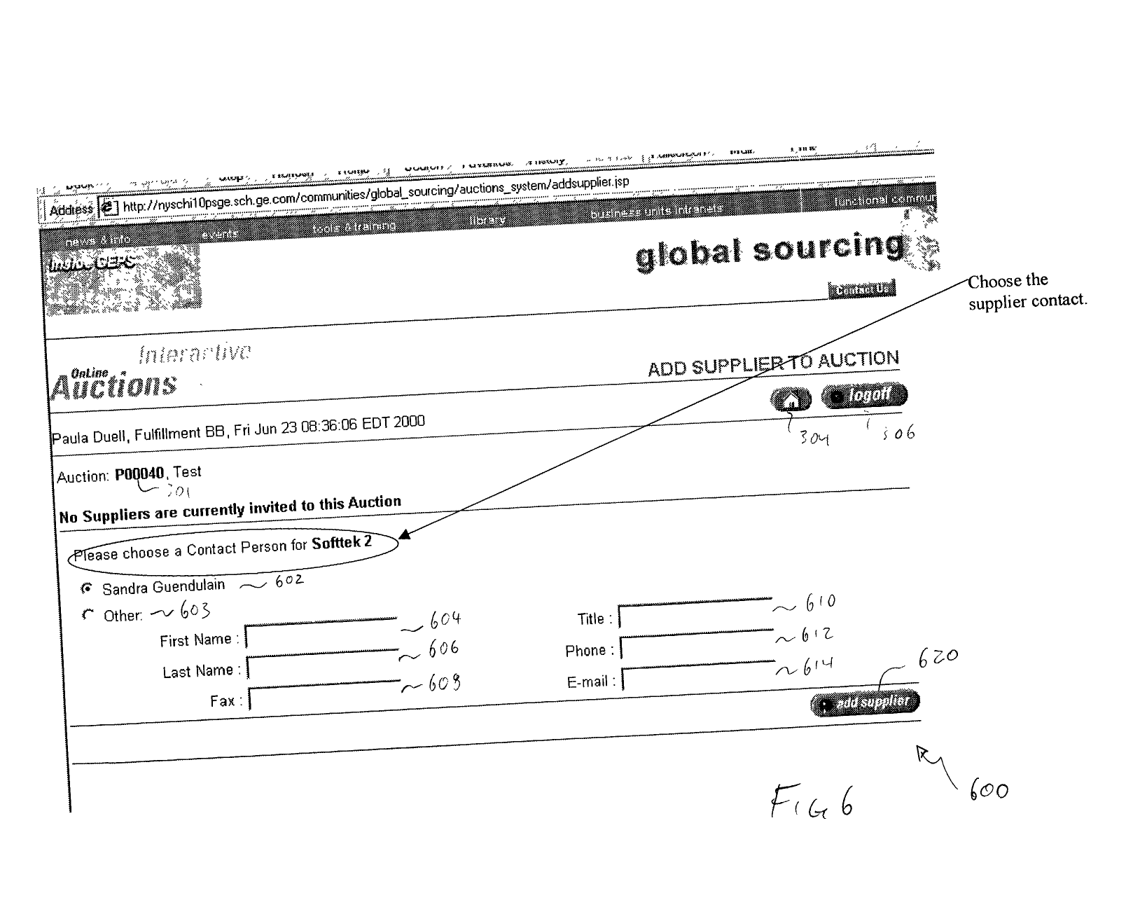

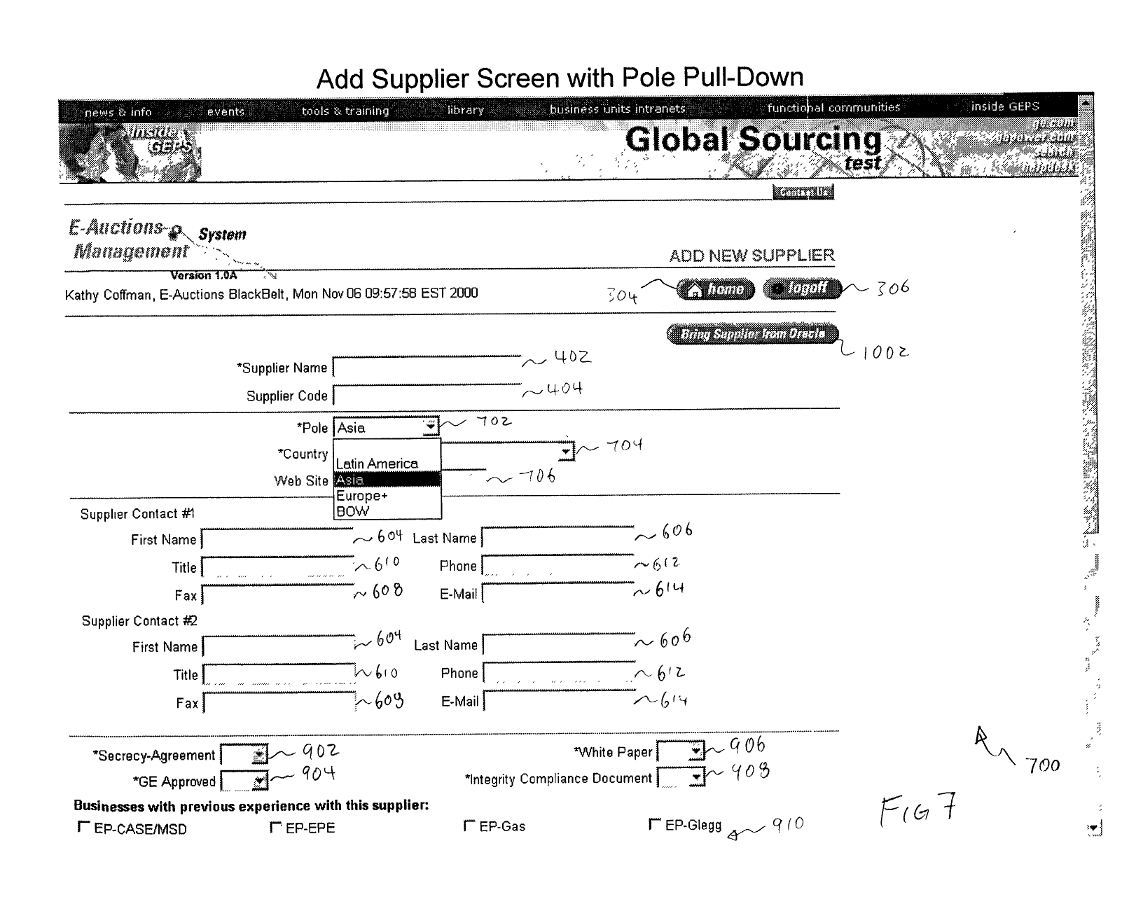

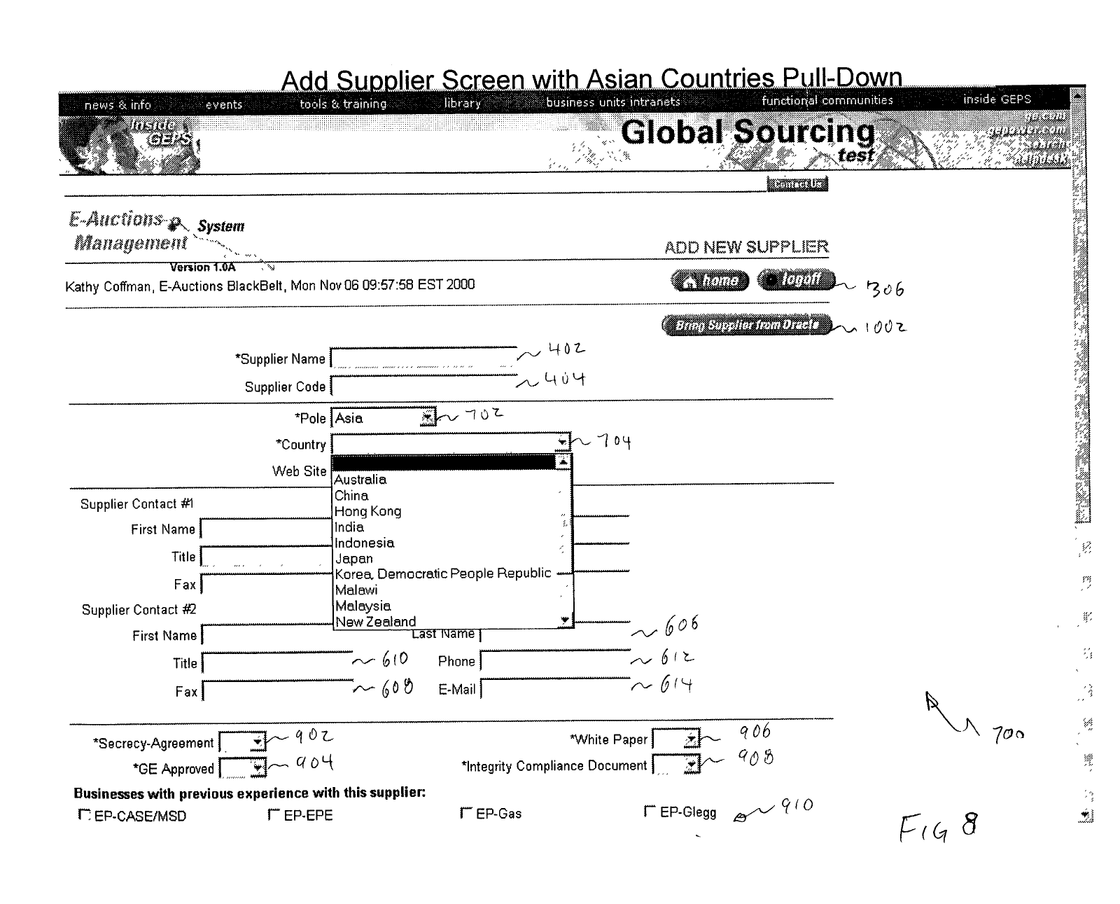

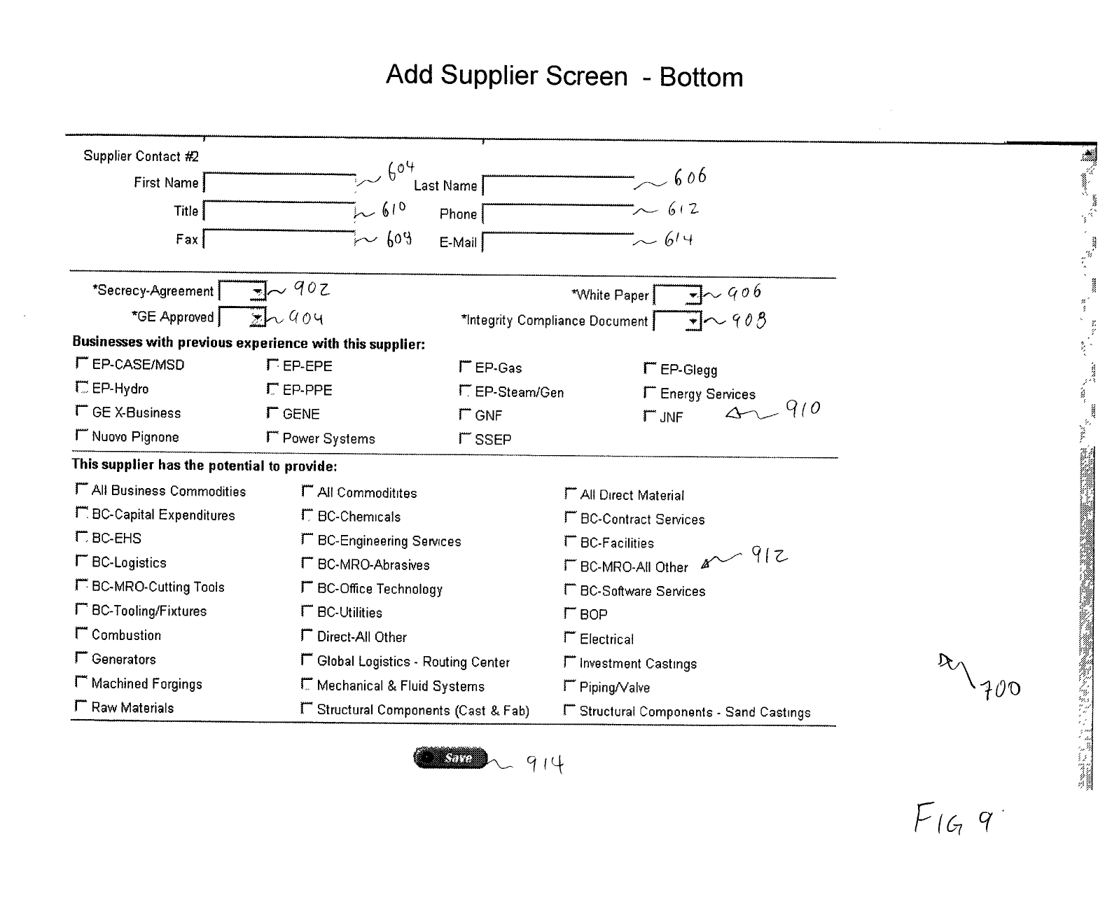

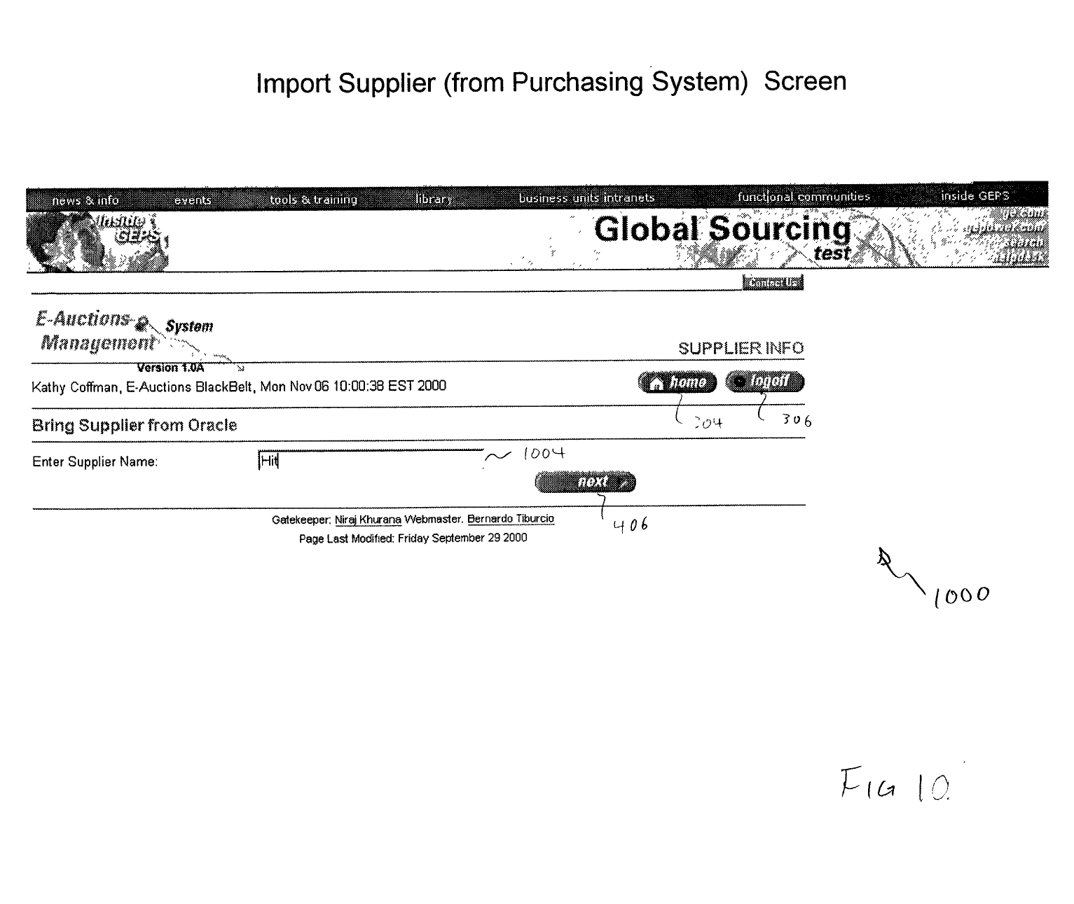

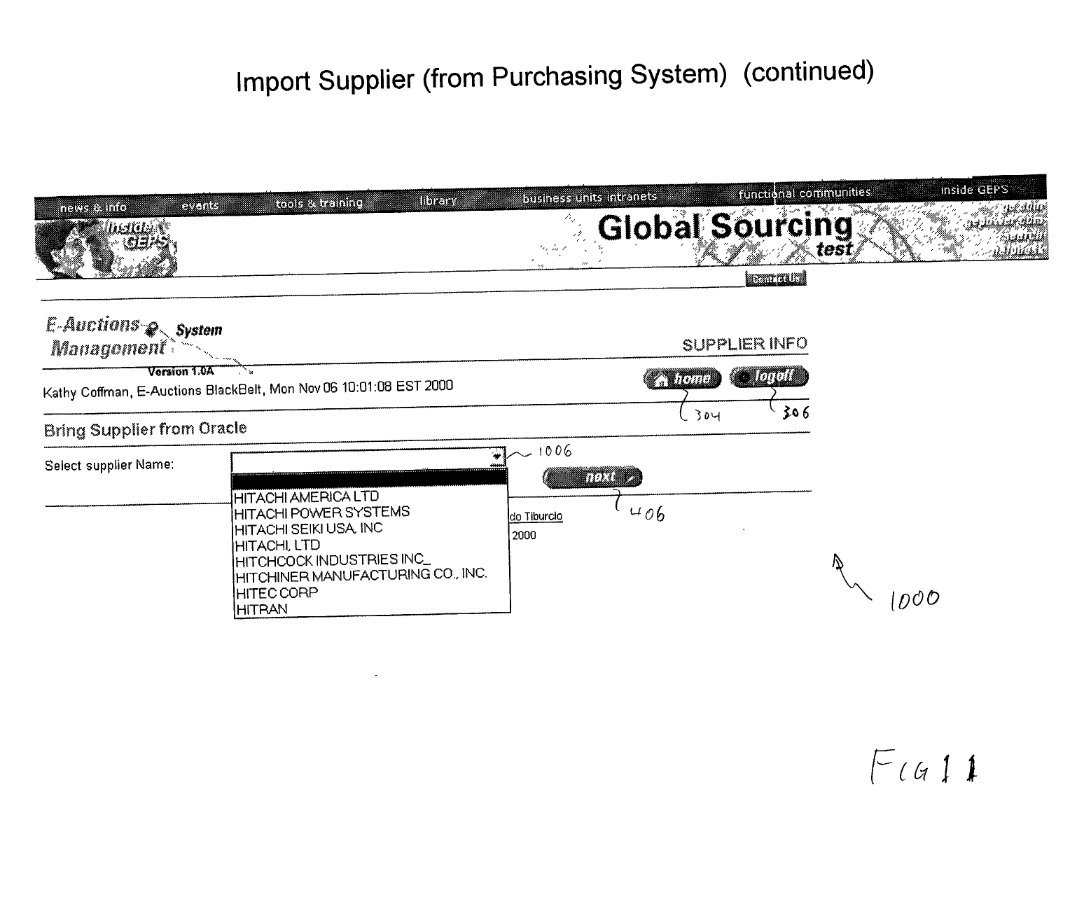

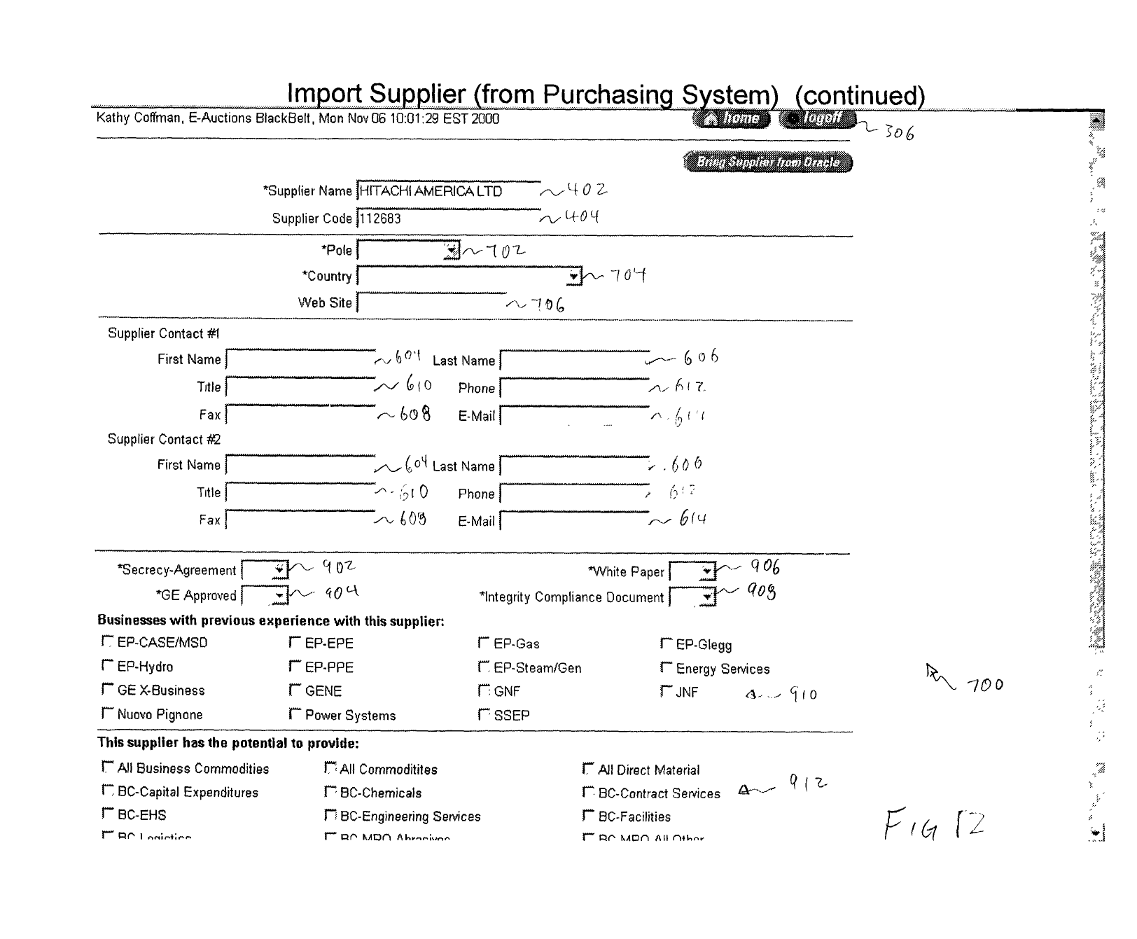

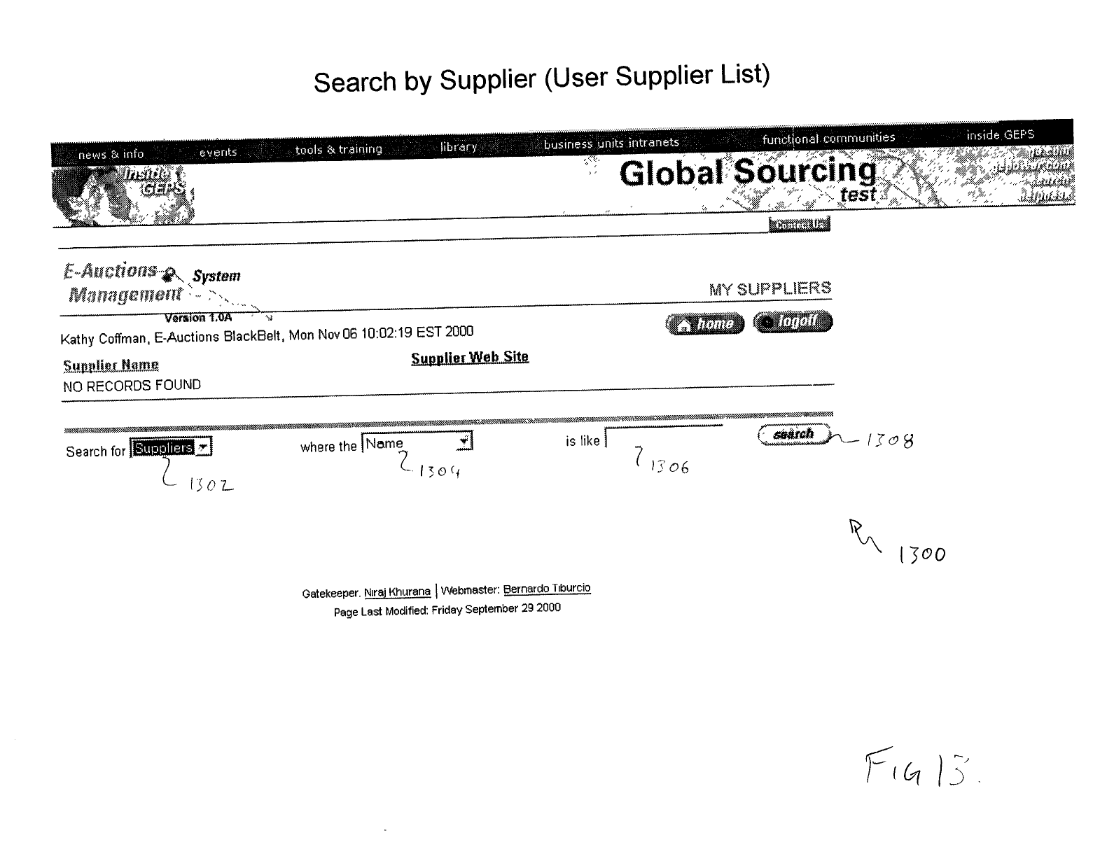

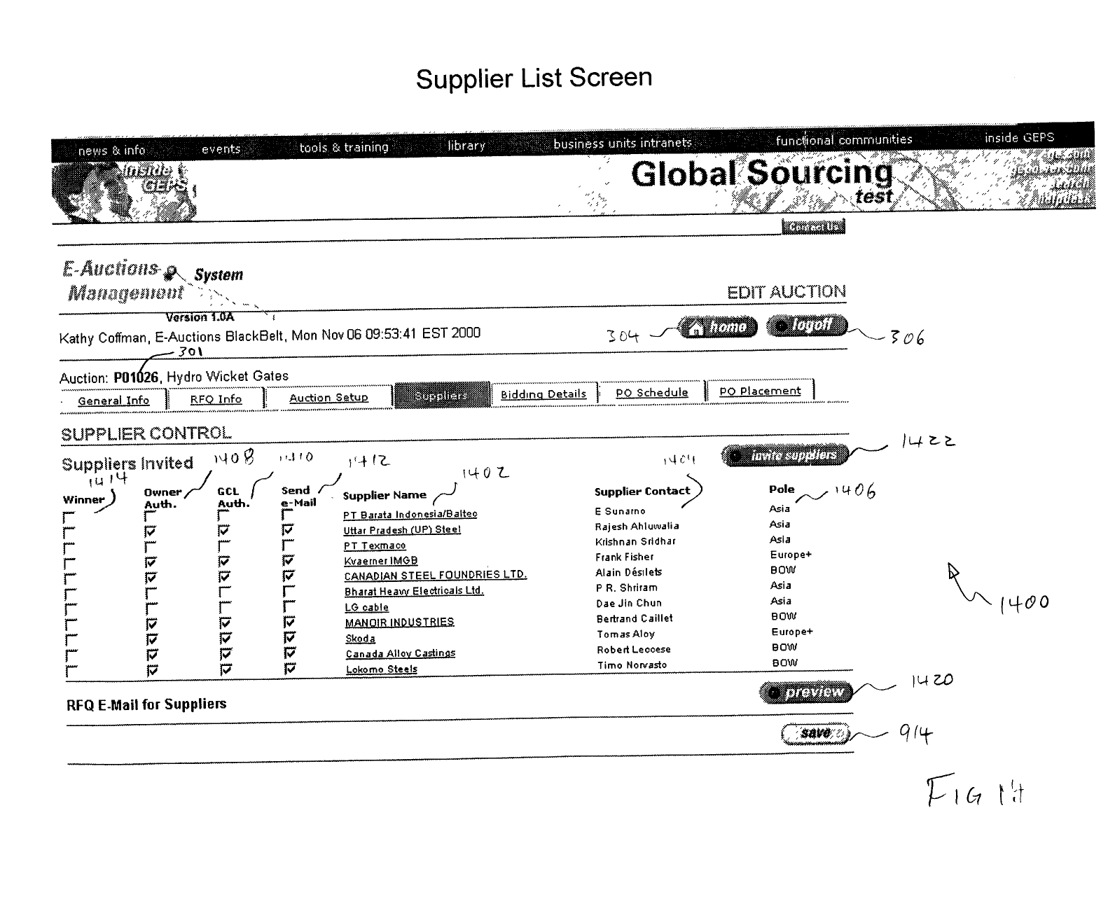

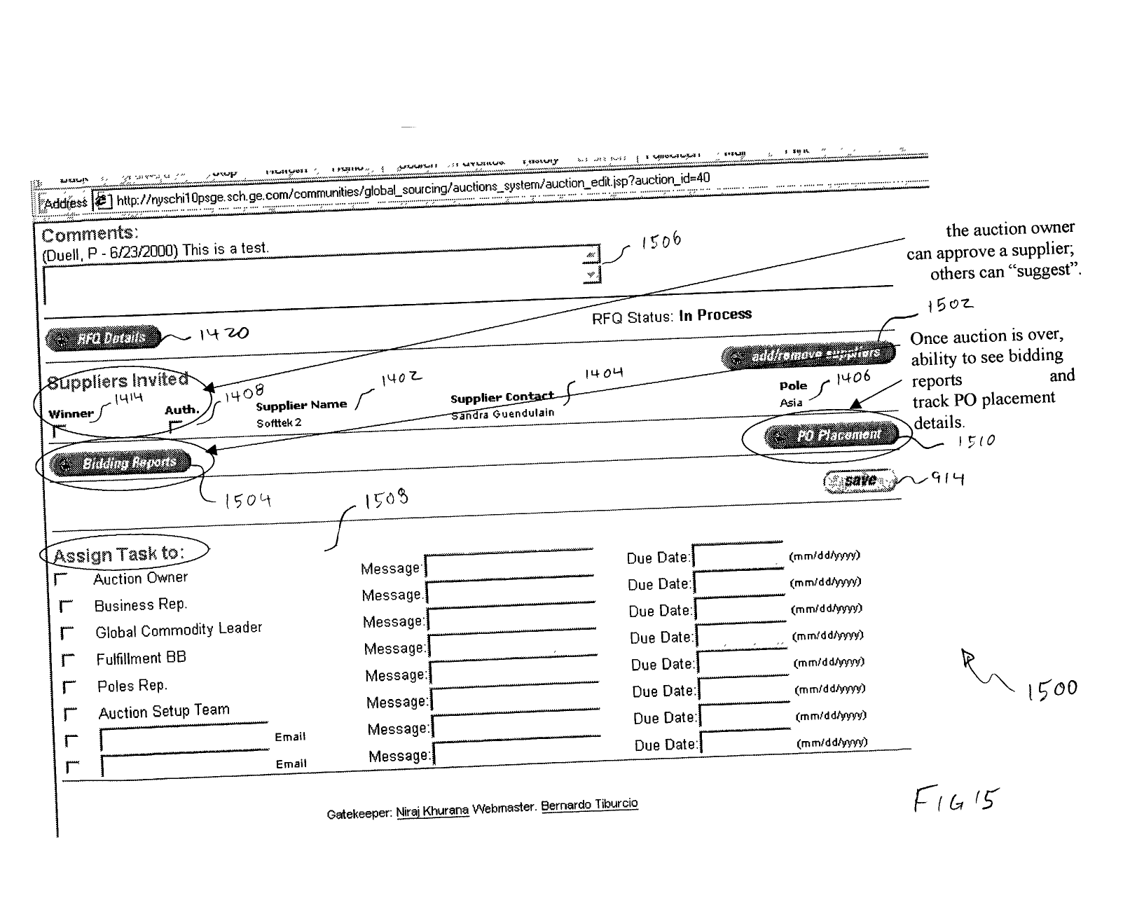

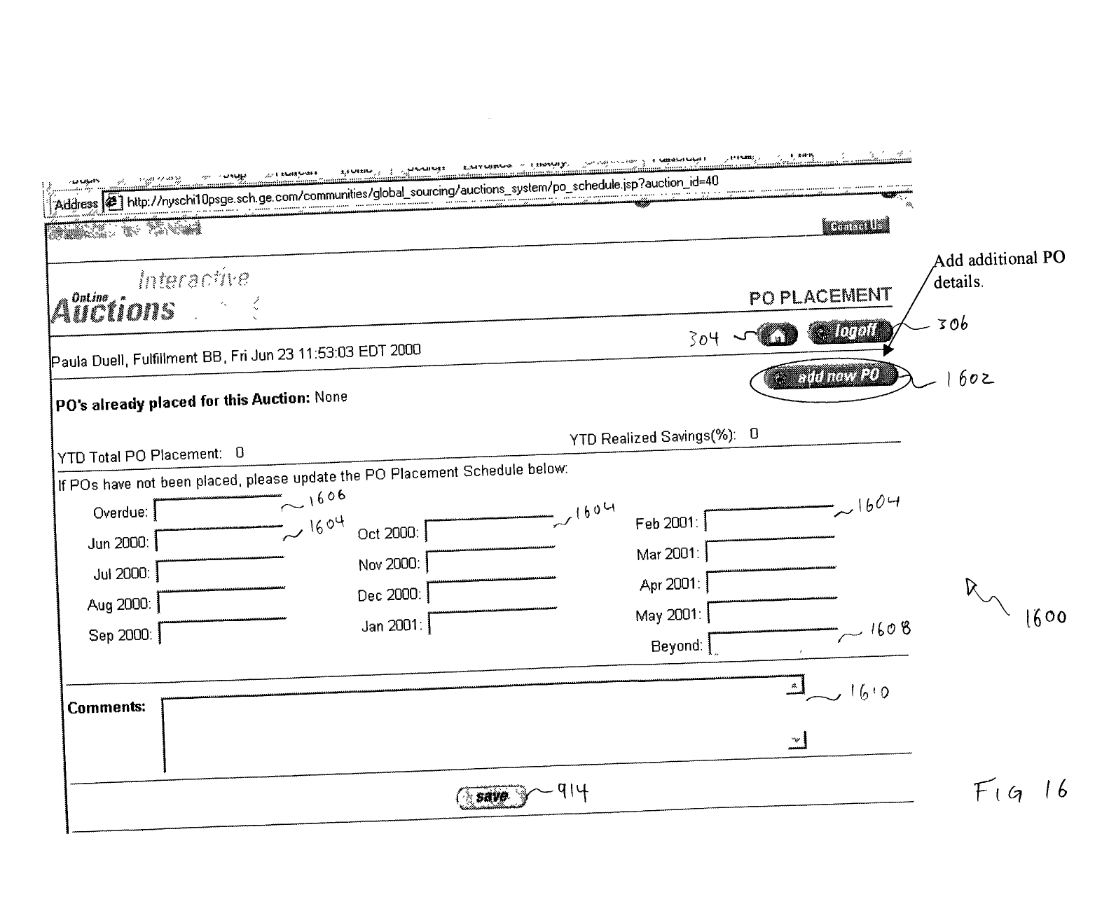

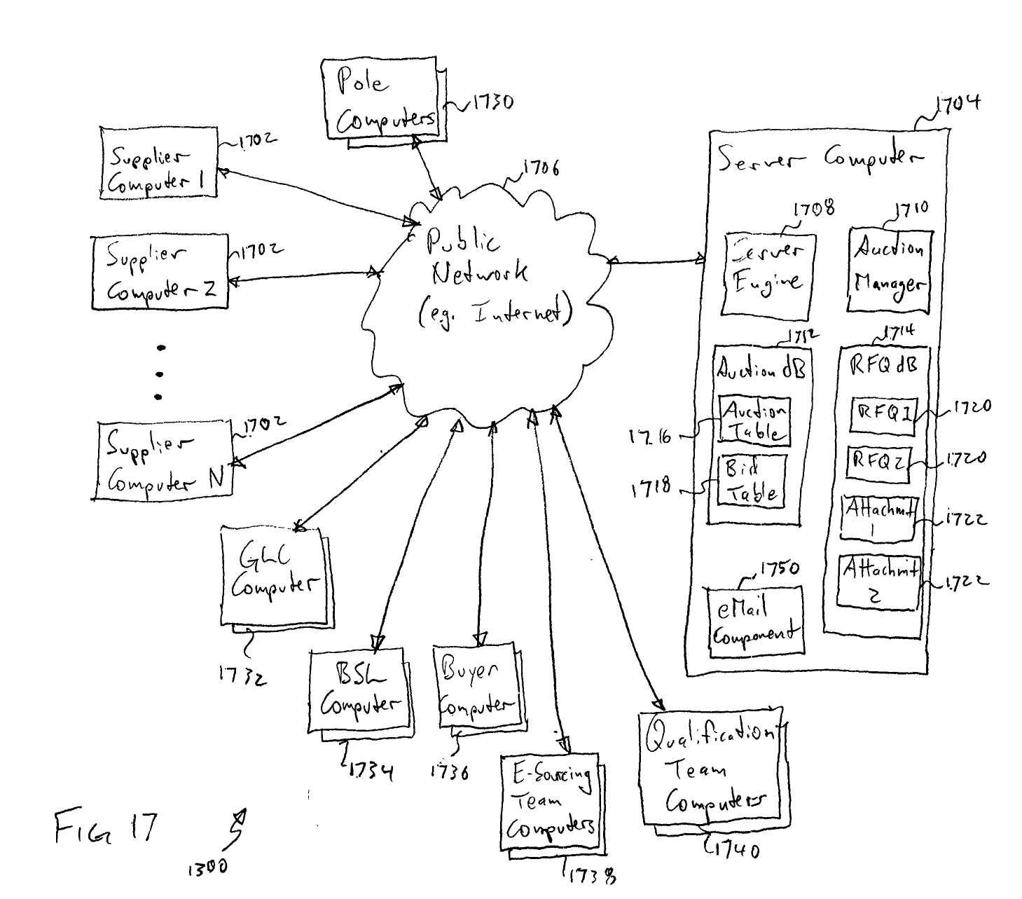

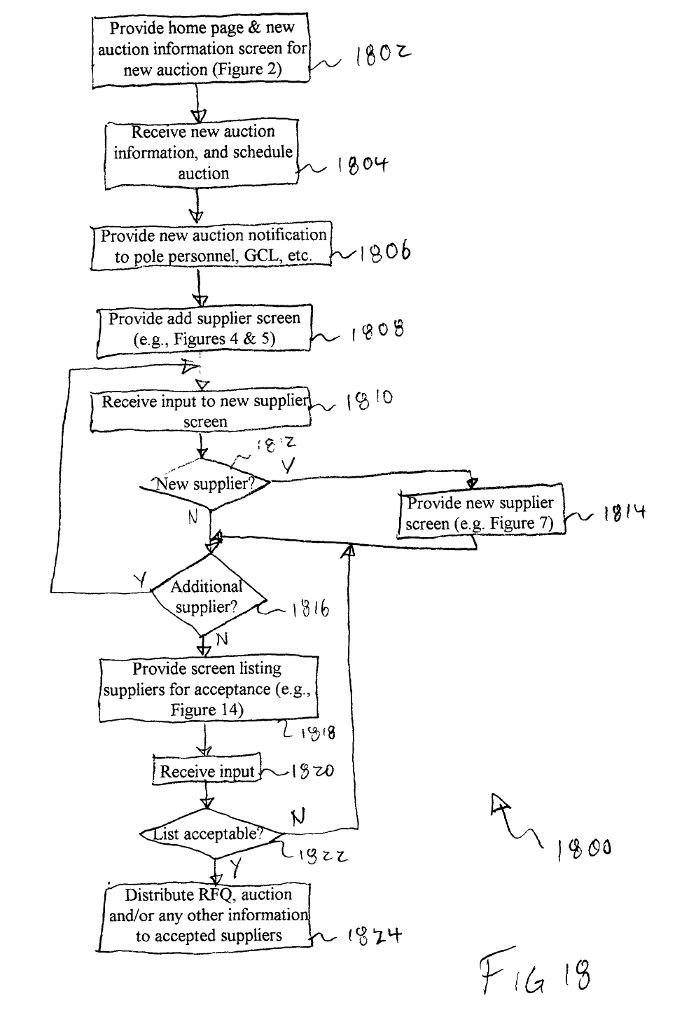

Referring to FIGS. 2 through 16, representative computer displays or Web pages will now be described with respect to listing, approving and contacting suppliers, such as for use with an electronic auction. The Web pages may be implemented in XML (Extensible Markup Language) or HTML (HyperText Markup Language) scripts that provide information to a user. The Web pages provide facilities to receive input data, such as in the form of fields of a form to be filled in, pull-down menus or entries allowing one or more of several entries to be selected, buttons, sliders, or other known user interface tools for receiving user input in a Web page. Of course, while one or more ways of displaying information to users in pages are shown and described herein, those skilled in the relevant art will recognize that various other alternatives may be employed. The terms “screen,” “Web page” and “page” are generally used interchangeably herein. While XML and HTML are described, various other methods of creating displayable data may be employed, such as the Wireless Access Protocol (“WAP”).

The Web pages are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general, a “link” refers to any resource locater identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), matrix or bitmapped formats. All aspects of the invention are described herein using a networked environment, some or all features may be implemented within a single-computer environment.

Referring to FIG. 2, a suitable, customized home page 200 is shown for a user of the system (e.g., “Paula Duell”). The home page 200 includes a Create New Auction link 202, which if selected by a user or buyer, causes retrieval and display of an appropriate Create New Auction screen, such as the Web page 204 shown in FIG. 2.

A “buyer,” as generally used herein, refers to an individual or group chiefly responsible for maintaining work flow by contracting for and insuring delivery of purchased items or services. Buyers are typically very familiar with a finite scope of purchased items, established suppliers of those items, and logistics and timing issues involved with procuring those items. In practice, buyers have traditionally handled negotiations for purchases. The buyer may often be the user or author who interacts with the Web page screens described herein.

In general, brief definitions of several terms used herein are preceded by the term being enclosed within double quotation marks. Such definitions, although brief, will help those skilled in the relevant art to more fully appreciate aspects of the invention based on the detailed description provided herein. Such definitions are further defined by the description of the invention as a whole (including the claims) and not simply by such definitions.

The buyer may be a “Business Electronic Sourcing Leader” (“BSL”) who is delegated by each business unit to migrate sourcing or requisitioning activities into more efficient electronic methods. The BSL's role with respect to electronic auctions is to ensure that business goals are met, such as sufficient percentage of procurement performed through electronic auctions, savings targets are established and accomplished, and the like.

Referring to FIG. 3, after completing one or more Web page forms to schedule an auction and create and RFQ, the system displays a Web page screen 300 acknowledging RFQ creation. An auction number 301 (e.g., “P00040”) is provided by the system and displayed in the screen. The auction number may be a key field linking all other forms and tools described herein. Using this field will allow the author or other user to retrieve electronic documents associated with a given auction. Other details regarding the generation of RFQs may be found in U.S. patent application Ser. No. ______, filed ______ entitled “Method and System for Electronic Document Handling Such as for Request For Quotations Under an Electronic Auction” (Attorney Docket No. 243768027US).

The screen 300 provides instructions to the author for completing the auction setup process, and provides a link 302 that allows the author to proceed to the next step. For example, the next step requires the author or other individuals to identify suppliers to whom the RFQ is to be transmitted. By clicking the link 302, the system transmits a message (such as an e-mail) containing the RFQ, auction detail information and associated documents to an identified Global Commodity Leader (defined below) for review and approval. Similarly, the system may submit a message to identified pole personnel (if any) to receive the RFQ and additional items, to identify potential suppliers in their poles. A home button 304 (shown as home icon on the button) allows the user to quickly return to the home page screen 200, while a log off button 306 allows the user to log off of the system.

Referring to FIG. 4, an example of a Web page screen for allowing an author to add one or more suppliers to an auction is shown as a screen 400. An Enter Supplier Name field 402 and an Enter Supplier Number field 404 allows a user to search for a supplier currently existing in one or more databases of the system based on the supplier's name or supplier number. The supplier number or vendor number is a key field, such as in an MRP database, for links to supplier contact information. An organization may not assign a supplier number until a supplier has been approved (e.g., evaluated and met criteria such as having completed a secrecy agreement and successfully met criteria such as those outlined in a “white paper,” described below). An author need only enter the first few letters of the supplier name in the field 402, or numbers in the field 404, and click a next button 406 to initiate a search. For example, after entering only the three letters “sof” in the Supplier Name field 402 and clicking the next button 406, the system presents a search results screen, such as a screen 500 shown in FIG. 5. The screen 500 includes a supplier name field 502 listing a supplier “Softtek 2”. The field 502 includes a pull-down menu that lists other suppliers meeting the search criteria (in this case, no other suppliers), as well as an option to permit the author to add a new supplier (an “Other” option). Selecting the “Other” option from the pull-down menu in the field 502 retrieves from the system a new supplier record screen that permits the author to insert data into several fields for the new supplier (similar to that shown in FIGS. 8 and 9).

After a supplier has been selected from the pull-down menu and the next button clicked, the system provides a supplier contact information screen 600 shown in FIG. 6. The screen 600 lists one or more contact people associated with the selected supplier (in this example, “Sandra Guendulain”) that may be selected by a button 602. If the appropriate contact person is not listed, the author may add the name and contact information for a new contact person by selecting another button 603 and entering first name, last name, fax, title, phone and e-mail information in fields 604, 606, 608, 610, 612 and 614, respectively. After selecting either option, the user clicks an add supplier button 620, and the system adds the selected supplier to a list of proposed suppliers to be added to an auction, as described below. After saving a new supplier record, the system automatically updates an alphabetical list of suppliers for use in pull-down menus or other user interface features.

Referring to FIGS. 7 through 13, examples of alternative Web page screens for adding suppliers to an auction are shown. Referring to FIG. 7, an add new supplier screen 700 is shown with a pole field 702. A “pole,” as generally used herein, refers to specific regions in the world that the business organization has targeted as having a low-cost supply base for items consumed by the organization. The field 702 is shown with a pull-down menu listing four poles: Latin America, Asia, Europe and BOW (“balance of world”). The Asian pole, for example, may be a preferred source of textile items or hand tools due to low labor rates within the region. A country field 704 lists the countries associated with the selected pole, such as countries listed in a pull-down menu in FIG. 8: Australia, China, Hong Kong, Asia, Indonesia, Japan, Korea, Malawi, Malaysia and New Zealand, as well as other Asian countries not shown. Within each identified pole, the organization may have or be affiliated with “sourcing engineers” or “pole personnel” who have the responsibility to identify and develop good suppliers within that region. Pole personnel are generally local nationals working directly with suppliers and national commerce organizations to bring business to their associated geographical region. Pole personnel may work with Global Commodity Leaders (“GCL”), where the GCL encourages bids under an electronic auction to suppliers within that pole.

A GCL has the responsibility to be a single commodity expert across an entire business (across distinct profit and loss centers). The GCL strategizes where and how to purchase, how to leverage volume and how to split purchases to best utilize or manage an available supply base. As indicated by their title, GCLs are expected to be familiar with the entire world's supply capability and price structure for their particular commodities, although buyers may actually purchase items and ensure delivery.

In one embodiment, the GCL may consider cross-business initiatives. “Crossbusiness,” as generally used herein, refers to sharing information for grouping purchased volumes of items to facilitate better negotiation with suppliers. Cross-business refers to collaboration between business units with each having different organizational structures and distinct operational objectives. For example, a large organization having an aircraft engine business and an industrial systems business may have totally different operations, but the businesses may be able to collaboratively buy common items such as hand tools or small batteries under leadership of the GCL. In general, while the processes are described herein for procuring items, the processes may also be performed for procuring services to be performed. A “separate business unit” or “business unit,” as generally used herein, refers to a separate profit and loss center or group within a larger business organization.

A Web site field 706 allows the author to input a URL of a supplier's Web site if the supplier has an Internet site. If a new supplier is being added who does not currently exist in the database, the author may provide information regarding the supplier, such as the supplier's name and country in fields 402 and 704, and contact information in fields 604 and 614. The system may automatically associate the appropriate pole based on the country entered in Country field 704. The system may also only add a Supplier Code after the supplier has been approved, as described herein.

Referring to FIG. 9, the screen 700 includes a Secrecy Agreement field 902 that requests the author to indicate whether a secrecy agreement is on file with respect to the selected supplier. The system may permit only the buyer, appropriate pole personnel, business-designated administrator or a legal contact within the organization to modify this mandatory field; the modification capability may reside with the person responsible for maintaining legal records of the required documents. In one embodiment, a link or icon may be provided (not shown) that allows a user to click thereon and retrieve a scanned image of the Secrecy Agreement on file to confirm such an agreement has been executed by the supplier. Only a “Yes” value in the field 902 will permit the system to distribute an RFQ and other information to a proposed supplier.

An Approved field 904 requires the author to input whether the selected supplier has been approved by the business organization (either by the author's business unit or other business units within the business organization), with the default set at “No.” If a “Yes” value is selected, then a Qualification auction may be conducted with suppliers approved to receive the RFQ but not previously qualified to supply the items being auctioned. The field 904 allows the system to segregate the supplier list to list only approved suppliers who are able to receive an invitation to bid on an auction and receive an RFQ for Qualification auctions. The system may restrict only a business-designated administrator or a legal contact within the organization to modify this mandatory field; the modification capability may reside with the person responsible for maintaining legal records of the required documents.

A “Production auction,” as generally used herein, refers to an auction where either all participants have already been fully qualified to supply the items/services being auctioned or where no qualifications are necessary for suppliers(such as to supply shop rags). Alternatively, a “Qualification auction” typically refers to an auction where the items (being offered by suppliers) must be qualified. While the depicted embodiment generally addresses reverse auctions, forward auctions or reverse-sealed auctions may be implemented. A “sealed auction,” as generally used herein, refers to an auction where bids or other information provided by the suppliers is not shared or made available to other suppliers. While the depicted embodiment at times shows or is described as having certain default values, those skilled in the relevant art will readily recognize that other default values may be employed.

A white paper field 906 requires the author or appropriate pole sourcing engineers to input whether the selected supplier has completed a white paper under the guidelines established for the item to be auctioned. A “white paper,” as generally used herein, refers to a business-standard questionnaire that queries a supplier through a self-survey for types of issues that would be investigated during a supplier-approval audit, such as financial practice issues, quality system issues, ethical issues, labor standards issues, etc. For example, the white paper may be a computerized spreadsheet having separate questionnaires for obtaining the following information about a potential supplier: initial preparatory information, prescreening information, supplier evaluation information, determination of a supplier's quality control systems, determination of delivery methods for the supplier, determination of regulatory compliance (e.g., labor, environmental health and quality, safety and the like), manufacturing and engineering capabilities, financial position, general business considerations (e.g., whether they have a Web site, e-mail, understand English, have labor dispute history and the like), etc. The supplier initial preparatory information may include obtaining information regarding the company's address, company's contacts, company's business structure, its major facilities, information regarding its manufacturing and engineering capabilities, its top customers, its quality assurance capabilities, etc. The prescreening information regarding a supplier may include more detailed information regarding the company's location, the company's employment breakdown regarding number of employees per manufacturing/design group, financial information regarding the company, more detailed manufacturing and engineering information regarding the company, more detailed information regarding its quality systems, information regarding the company's transportation and delivery capabilities, information regarding the company's compliance with respect to relevant regulatory matters (including health and safety), information regarding visual inspection of the supplier's facilities and intellectual property information. The supplier evaluation information or form may include further commercial and financial information regarding the supplier, further detailed information regarding the manufacturing, engineering and quality assurance capabilities of the supplier, further information regarding regulatory compliance, etc. All of these documents, in turn, may be considered, as a whole, the “white paper.”

In general, approving a supplier is a process of audits (financial, legal, ethical, etc.) to determine whether the supplier is an entity capable of supplying items for the organization, and which conforms to all relevant laws, ethics and financial practices required by the organization conducting the auction. The white paper may be a spreadsheet or other electronic document completed by quality leaders, and manually checked by pole personnel or the quality leaders. While not shown, the system may permit the buyer or other user to request any business-specific documents required for ISO procedures, or to create and be issued supplier numbers for a new supplier for whom qualification procedures have been completed. As explained herein, if the supplier has not completed all required fields in a white paper and/or the business has not sufficiently completed qualification auditing procedures, the system will disable inclusion of a supplier within an auction. Thus, the system will prohibit the RFQ, and possibly even e-mail messages, from being sent to such supplier. However, when all mandatory fields in the white paper have been completed and other required qualification procedures have been performed, the system will enable access to that supplier (such as changing the value of the Approved field 904).

Under an alternative embodiment, an automated Electronic Supplier Management System may be provided, as either a separate system, or integrated with the auction system. The Electronic Supplier Management System may include web-enabled white-paper forms for expedited completion.

“Quality engineer” and “quality leader” refer to individuals within a quality program in the business organization. The quality engineers and leaders become involved in any process that requires changes to either ISO procedures or supplier audits. Quality engineers/leaders may be black belts. The quality engineers and leaders may determine how much of the white paper a proposed supplier must complete before being permitted to participate in an auction for a specified item and receive an RFQ.

A commodity “black belt” (“BB”), as generally used herein, refers to an individual within the business organization that characterizes and optimizes key processes that exert undue influence on the business landscape. BBs identify and execute projects that will reduce errors and defects in industrial and commercial processes and in products and services (e.g., reduce labor, material, cycle time and inventory). Further information regarding black belts may be found in M. Harry and R. Schroeder, Six Sigma Breakthrough Management Strategy Revolutioning the World's Top Corporations (Currency Press, 2000).

As with the secrecy agreement, unless a “yes” value is entered in field 906, the system will not distribute or forward RFQs or other information to a selected supplier. The system may permit only a sourcing quality engineer or pole personnel to complete field 906. In one embodiment, an icon or link is provided to permit an author to click thereon and retrieve a scanned version of the white paper to determine how thoroughly the supplier has completed it. Alternatively, the button or link may retrieve an electronic copy of the white paper that may have been completed by the supplier (possibly with incomplete fields or sections highlighted). Under this alternative, the system stores in electronic form copies of all white papers completed by suppliers, where such white papers may be documents created under a word processing application, Web-based forms, and the like.

An Integrity Compliance Document field 908 refers to whether the supplier has completed an integrity document, where the document concerns such integrity issues as gifts and gratuities that they may pay or have paid and which may be restricted for policy reasons by the business organization.

A previous experience section 910 lists business units in the organization and allows the author to identify other business units that have previously worked with the supplier. Based on previously conducted auctions, the system may automatically check one or more boxes associated with business units with respect to a given business unit so that upon retrieving a record associated with a supplier, one or more listed business units having such experience are already noted.

A supplier potential section 912 allows the author to identify and select one or more groups of business commodities or items that the supplier may provide to the business organization. Again, the system may automatically note one or more options within section 912 based on previous auctions and corresponding information already stored in the database. The various options are self-explanatory in FIG. 9. “BC” refers to business commodities, which are typically “indirect” products, or material that does not become an integral part of a product the business organization sells to customers. Instead, such business commodities are consumed during operations. An example is printed paper, carbide tooling, etc.; if the business organization creates gas turbines, gas turbines do not contain printing paper or carbide tools, but the organization's ability to produce such turbines depends on operations that consume these items. A save button 914 allows the author to save entries to the screen 700 before proceeding. The newly-saved supplier may then be added as a proposed supplier to an auction, if the author is currently identifying suppliers for an auction.

The author may retrieve supplier information previously stored in a database of the system by clicking a button 1002 (FIG. 7) to retrieve a search screen 1000 shown in FIG. 10. When the first few letters of a supplier's name are entered in a Supplier Name field 1004, the system may list suppliers stored in the database which meet the search criteria, such as shown in a pull-down menu 1006 in FIG. 11. By selecting one of the suppliers in the pull-down menu, such as “Hitachi America Limited,” and clicking the next button 406, the author enables the system to retrieve and display a supplier record associated with the selected supplier, such as that shown in FIG. 12. While not shown in this representation of FIG. 12, if more information, such as contact information, businesses who have previously dealt with the supplier, and items or commodities that the supplier can provide were available in the database with respect to the selected supplier, it would be shown in the actual representation of FIG. 12.

Referring to FIG. 13, the system may provide a supplier search screen 1300. A search for field 1302 allows the author to specify what the system is to search for, such as “suppliers” or “contacts” (which may be selected from a pull-down menu). A where field 1304 allows the author to specify the particular data or field to be queried, such as name, supplier number, e-mail address, etc. (which also may be selected from a pull-down menu). A query field 1306 allows the author to specify what in particular the system is to search for. In other words, the search for field 1302 identifies the group of records to be searched, the where field 1304 identifies one or more fields to be searched within the records, and the query field 1306 specifies a search string to be searched within the fields of the records. A search button 1308 initiates the search after the author has completed fields 1302, 1304 and 1306. Search and database query techniques are well-known to those skilled in the relevant art. After retrieving a record for a desired supplier, the supplier may then be added to a list of suppliers proposed for an auction.

In general, the buyer and pole personnel input supplier selection. The GCL may also identify suppliers. A minimum of two days may be required for low cost countries (“LCCs”), but one day is required for the balance of the world (“BOW”). In general, the minimum time set should take into consideration how long the supplier selection process should take based on the intended scope of the auction.

FIG. 14 shows an example of a Web page 1400 listing suppliers to be included in an auction. As shown, suppliers are identified by name 1402 (with associated link to the supplier's record), a supplier contact 1404 and the pole 1406 associated with the supplier. The owner of the auction and the GCL may separately authorize or accept the supplier for participation in the auction, represented by sections 1408 and 1410, respectively. A Send E-mail section 1412 allows the user to determine whether the RFQ is to be e-mailed to suppliers who have been accepted or invited to participate in the auction.

In general, the supplier list may be separated into three sections: qualified to bid, proposed to bid and accepted for bidding. “Qualified to bid” suppliers are those suppliers the buyer or GCL has previously identified as being qualified to manufacture the item requested (for production auctions only). “Proposed to bid” suppliers are suppliers offered by the buyer, pole personnel, GCL, or other personnel to be considered for input to the auction. “Accepted for bidding” suppliers are those suppliers on an official list of suppliers who may be included in an auction but who must later be qualified (some of whom may already have been qualified). As shown in FIG. 14, suppliers who are “proposed to bid” are listed in the screen 1400, while suppliers who are “accepted for bidding” are those for whom the approved field 904 is “yes” or one or more of the Secrecy Agreement, white paper, and Integrity Compliance Document fields 902, 906 and 908, respectively, are “yes.” Suppliers who are “qualified to bid” are those who have already been fully qualified by the purchasing business to produce the item being auctioned. (Qualification may involve destructive or non-destructive testing to ensure quality and applicability of the item for its intended use.)

The auction owner, GCL or possibly other individuals may select or deselect suppliers, such as by checking or unchecking the appropriate boxes in the screen 1400. In one embodiment, the auction owner has initial authority to accept suppliers for bidding, but the GCL has the final authority to accept suppliers for inclusion on the list. If the GCL determines that a supplier is not to be put on the list, then the GCL may input a reason, such as selecting a reason code from a drop-down list of codes in a pop-up Web page form or dialog box (not shown). Such reason codes may include the following: the supplier's capability to supply the item was not validated, the supplier exhibited unacceptable prior performance on quality and/or delivery, the supplier has no domestic distribution or service organization, and/or the supplier did not meet pre-requirements (such as those detailed in the white paper). In other embodiments, of course, GCL authorization may not be required, and suppliers may be accepted if either the auction owner or the GCL checks a box under sections 1408 or 1410.

The system will not close out an auction until a selection is made, if any. The system automatically imports all bids received from suppliers, and permits the auction owner (such as the buyer) to denote the supplier or suppliers who will receive a purchase order and the dollar amount per supplier as a portion of a total gross financial value.

A winner section 1414 identifies which supplier won the auction. The system may automatically mark the appropriate box corresponding to the winning supplier after the auction ends. Alternatively, the auction owner may manually select the appropriate box after the auction owner determines the winner.

After time expires for inputting suppliers (e.g., one or two days as noted above), the auction owner may preview the electronic auction and RFQ before it is released to suppliers by clicking a button 1420. In one embodiment, the system may automatically send an email or other notification to the auction owner stating, for example, that the supplier selection is complete and asking the auction owner to verify that all auction settings are complete and release the auction invitation to the selected suppliers. The automatic e-mail message may present a summary page (not shown) or provide a link to a page that details all auction setting information and contains a supplier list so that the auction details may be readily reviewed by the auction owner. If all settings are in order, the auction owner may click on a virtual button 1422 to release (e.g., e-mail) the electronic RFQ to identified suppliers.

The system may automatically create an e-mail distribution list based on the suppliers accepted when the invite suppliers button 1422 is selected. Thus, the system automatically creates a group e-mail distribution list that the system, buyer, or other individual may access to rapidly send information to all suppliers. The auction number 301, as noted above, is the key field associated with the created distribution list. Likewise, the system may automatically compile a list of affected pole personnel based on countries in which suppliers are located. The system may compile such a pole personnel distribution list based not only on pole selections chosen by the buyer or auction owner, but also based on suppliers that may be later suggested after the auction has been initially scheduled. The buyer or database administrators may use the affected pole personnel list to review and edit any contact information with respect to such personnel where necessary.

The system may automatically notify the auction owner of any suppliers who have been accepted, but who have yet to be approved when the RFQ is distributed (e.g., the invite suppliers button 1422 is selected). Alternatively, the system may notify the auction owner of any new suppliers who have been suggested and added to the list (whether or not they have been accepted). The system may automatically issue queries, such as e-mail messages, to accepted suppliers regarding whether the suppliers will be participating. Such e-mail messages may be sent to the auction owner or other individuals during a user-defined period before the auction.

Referring to FIG. 15, an alternative or additional Web page to that of FIG. 14 is shown as a Web page screen 1500. As shown, only the auction owner may authorize the addition of a supplier in this screen (as shown by the section 1408). An add/remove supplier button 1502 allows the user to open a separate window or dialog box that permits the user to add or remove suppliers from a list of proposed suppliers. A bidding reports button 1504 allows the user to open a separate window (not shown) to show a list of all suppliers who bid in the auction, amount of their bids and time of such bids. The system may also provide appropriate business graphics, such as bid value versus time graph to thereby visually analyze auction results after the auction ends. A comments field 1506 allows the user to input comments with respect to the auction, while an Assign Task section 1508 allows the user to assign tasks to individuals involved with the auction. Further details regarding assigning tasks to individuals under the auction may be found in U.S. patent application Ser. No. ______, filed ______, entitled “Method and System for Assigning and Tracking Tasks, Such as Under an Electronic Auction” (Attorney Docket No. 243768039US).

A purchase order (“PO”) placement button 1510 allows the user to retrieve a Web page screen for placing one or more purchase orders with the winning supplier. Referring to FIG. 16, an example of a PO placement and tracking screen 1600 is shown. An add new PO button 1602 allows the user to open a new purchase order electronic form and add purchase order details. The system may automatically input all fields currently stored within it, such as the winning supplier's name, address, contact information and the like. The system may highlight blank fields that the user must complete.

The screen 1600 allows the user to establish a purchase order (“PO”) placement schedule. In one embodiment, PO tracking is manually performed. The screen 1600 provides the business with an approximation for when they need to place orders with the auction's intent, rather than changing “terms of implied contract” after the auction is concluded. Alternatively, the auction system may be integrated with the purchasing system for automatic generation of purchase orders.

As shown, twelve fields 1604 representing consecutive months over the period of a year period allow the user to input dates on which purchase orders are to be forwarded to the winning supplier. Preferably, purchase orders are electronically forwarded to the winning supplier. Alternatively, the user may input a fiscal week within such fields 1604 to identify the week during which a purchase order is to be sent. Not all of the fields 1604 need to be completed; a purchase order schedule is dependent upon the item being procured and the business' needs. An overdue field 1606 allows the user to specify any purchase orders that are overdue and the dates of such purchase orders. Alternatively, the overdue field 1606 may permit the user to specify when a purchase order is considered overdue (such as one week late). Overdue purchase orders, under this alternative, cause the system to send warning messages to the supplier. A beyond field 1608 allows the user to estimate purchase orders to be placed beyond the one-year window. The beyond field may allow the user to input a periodic schedule for future purchase orders (e.g., monthly, every six weeks, etc.). A comments field 1610 allows the user to input any comments with respect to purchase order placement and schedule.

The system may also display on one or more pages a Create Supplier Approval form button (not shown) that allows the system to generate a printable form using fields described above (such as those in the screen 700) to thereby generate a physical supplier approval form. A user may be required to select the specific contact if more than one are associated with a given supplier. Remaining fields in the form may be boxes to be checked, similar to that in the electronic screens depicted herein.

The MRP or purchasing system may automatically generate purchase orders and electronically transmit, fax, mail or otherwise deliver such purchase orders to the winning supplier. The buyer may have previously prepared a purchase order, which has been approved, but simply needed a supplier name and address to be input thereto. After a winning supplier has been identified, the buyer may simply input the name and address of the supplier into the previously generated purchase order to quickly and efficiently place the first order and other orders as scheduled under the page of FIG. 16.

Further details regarding specific aspects of the auction method and further details regarding Web page or other electronic interfaces for an electronic procurement system may be found in the above-referenced patent applications, and in U.S. patent application Ser. No. ______, filed ______, entitled “Method and System for Providing International Procurement, Such as Via an Electronic Reverse Auction” (Attorney Docket No. 243768038US).

A suitable hardware platform for implementing an electronic auction will now be described with respect to FIG. 17. Referring to FIG. 17, a block diagram illustrating an example of components of the electronic auction system described above are shown. One or more client or supplier computers 1702 and a server computer 1704 are interconnected via a public network such as the Internet 1706. The computers may include a central processing unit, memory, input devices (e.g., keyboard and pointing devices), output devices (e.g., display devices and printers) and storage devices (e.g., optical and/or magnetic disk drives). All are not shown in FIG. 17, but are well known to those skilled in the relevant art. The memory and storage devices are computer-readable media containing computer instructions that implement the auction system. The supplier computers may use a browser to access the Web pages via the Internet.

The server computer implements the auction system. The server computer system includes a server engine 1708, an auction manager 1710, an auction database 1712 and an RFQ database 1714. The server engine receives requests for resources (e.g., Web pages) via the Internet and coordinates the generation and transmission of the resources. The auction manager coordinates the conducting of the auctions. The auction manager stores auction listings and bidding histories in the auction database. When an auction closes, the auction manager supplies the supplier's submitted bids to the individual conducting the auction, and may provide a listing of bids in increasing order of price. The auction database includes an auction table 1716 and a bid table 1718. The auction table includes an entry for each auction conducted by various buyers within the business organization. The bid table includes an entry for each bid that was placed by a supplier during each auction, with corresponding indicators or links to the appropriate auction in the auction table.

The RFQ database includes one or more electronically generated RFQ's 1720 (two of which are shown in FIG. 17) and associated electronic attachments 1722. While shown in FIG. 17 as stored in the RFQ database of the server computer, attachments (or other documents such as electronic RFQ's) may be stored on another computer. The server computer may, of course, store additional documents, such as electronic qualification plans, electronic white papers and other supplier approval documentation, and other electronic documents or forms described herein.

The server computer is also intercoupled with other computers associated with the business organization, such as one or more pole computers 1730, GCL computers 1732, BSL computers 1734, buyer computers 1736, e-sourcing team computers 1738 and qualification team computers 1740. A “Qualification Team,” as generally used herein, refers to a team comprised of individuals who work for production operations. Depending upon the level of qualification required, the following types of personnel may be involved: manufacturing engineers, buyers, sourcing quality engineers, environmental health and safety engineers, financial analysts, operations leaders and/or machinists/operators. All of the computers depicted are similar to the supplier computers described above. Additionally, such computers may communicate via electronic mail. Thus, the server computer may include an electronic mail component 1750 to facilitate electronic communication between such computers. While one server computer is generally shown in FIG. 17, more than one server computer may, of course, be employed, such as a server computer for performing auctions (and thus employing the auction manager and auction database), another server computer for providing electronic mail, purchasing, MRP and/or other functions described herein, and a third Web server computer for handling some or all of the various electronic documents and pages described herein. One server computer may be coupled to the computers 1732, 1736 and 1740 (and possibly other computers) via an intranet or private computer network, while the server computer may in turn be coupled to external server computers and the supplier computers 1702 via a public computer network such as the Internet.

While wired connections are shown, the various computers may be connected via wireless connections. The invention can be embodied in a special purpose computer or data processor specifically programmed, configured or constructed to perform one or more of the computer-executable functions described in detail herein. The invention can be practiced and distributed in computing environments where tasks or modules are performed by remote processing devices, which are linked by a communications network. Aspects of the invention described herein may be stored or distributed on computer-readable media, including magnetic, optically readable and removable computer disks, as well as distributed electronically over the Internet or other networks (including wireless networks). Those skilled in the relevant art will recognize that portions of the invention reside on a server computer, while corresponding portions may reside on other computers. Data structures and transmissions of data particular to aspects of the invention are also encompassed within the scope of the invention. Additionally, the term “computer,” as generally used herein, refers to any data processing device, including portable computers, palm-top computers, personal digital assistants (PDA), Internet appliances, cellular or mobile telephones, wearable computers, set-top boxes, etc.

Referring to FIG. 18, an example of a flow diagram illustrating a method of listing, approving and contacting suppliers is shown as a method 1800. Beginning in block 1802, the system (server computer) provides a home page, a new auction information page, and other necessary screens, such as the screens shown in FIG. 2. In block 1804, the system receives new auction information from the user and schedules the auction in a master schedule for all auctions conducted by the system. In block 1806, the system provides new auction notification to appropriate pole personnel, the GCL and other individuals in the organization who need to be aware of the auction, such as individuals who may have tasks assigned to them, including an e-auction team. As noted herein, such notification may be by electronic mail or by any other means.

An “e-auctions” or “e-sourcing” team, as generally used herein, refers to a central functional group whose purpose is to schedule and facilitate electronic commerce for all business units. The group ensures that both buyers and suppliers have appropriate protected access to business tools used to prepare for and conduct electronic auctions. This group maintains a help desk during auction events to assist with any technical problems or other questions that may arise, to thereby facilitate the auction. The group ensures training of all users, both buyers and suppliers, in using the process. Furthermore, the group reports overall business metrics with respect to electronic procurement as it relates to business objectives or a “business road map.”

In block 1808, the system provides one or more add supplier screens, such as the screen in FIGS. 4 and 5. In block 1810, the system receives user input to the new supplier screen. In block 1812, the system determines whether the input requests a new supplier to be added, and if so, in block 1814, provides a new supplier screen (e.g., the screen in FIG. 7) and receives appropriate user input to that screen. In block 1816, the system determines whether any additional suppliers are to be added, and if so, the method loops back to block 1810. If not, then in block 1818, the system provides a screen listing suppliers suggested for the auction (e.g., the screen in FIG. 7) and receives appropriate user input to that screen. In block 1816, the system determines whether any additional suppliers are to be added, and if so, the method loops back to block 1810. If not, then in block 1818, the system provides a screen listing suppliers for acceptance in the auction (e.g., the screen of FIG. 14). In block 1820, the system receives user input, such as accepting or rejecting one or more suppliers in the screen listing of suppliers.

In block 1822, the system determines whether the list is acceptable, and if not, loops back to block 1816. If the list of suppliers is acceptable, then in block 1824, the system automatically and electronically distributes the RFQ, auction information and any other information to accepted suppliers. Those skilled in the relevant art will recognize that the method 1800 depicted in FIG. 18 provides only some of the higher-level functions described herein; various other functions provided by the system are not depicted, but will be recognized by those skilled in the relevant art based on the detailed description provided herein.

Various additional screens and alternative embodiments are possible within the system described herein. For example, each screen may include “add” or “info” buttons to be used throughout, alone, or together with a “key” or “legend” button or on a menu bar. These permit the author to click thereon for information regarding what information is to be added to a field, or further details regarding information provided when the info button is clicked. “Create new . . . ” fields may be added throughout the screens to permit the author to add new entries to pull-down menus.

The system checks for internal consistencies and conflicts between fields completed by the author. For example, if a user selected a proposed supplier from a given pole, but the auction had previously excluded suppliers from that pole, the system would provide the author with an error message and request the author to either modify the supplier's information (e.g., pole or country fields 702 or 704) or choose a new supplier. Likewise, while the system automatically inputs certain fields based on links between fields (such as the country field 704 being linked to the pole field 702), the system will provide error messages to the author when an entered field conflicts with logic in the system for another field and request the user provide accurate form completion.

The Web page screens described herein may include fewer or more fields than those depicted or described herein. For example, the supplier screen 700 may include additional fields for information regarding a supplier, such as the following: commercially familiar name, legal name of business, purchase order address, manufacturing address and buyer's experience. The commercially familiar name may be any tradename, acronym, dba or the like, such as “IBM.” The legal name of the business field would provide the full legal name of the business, such as “International Business Machines Corporation.” The purchase order and manufacturing addresses would include all subfields to fully specify the addresses to which purchase orders are to be sent and addresses at which manufacturing locations exist. The buyer's experience field may include a comment field for buyers or other individuals to input remarks about how good or bad an experience with the supplier or particular supplier contact was. The system would automatically assign a name to the person entering such remarks, as well as the date such remarks were entered.

The system may permit a user to search a supplier list based on higher level search criteria, such as commodities or items that the supplier may provide (based on selected items from section 912). Contacts for each supplier may be specified for particular commodities supplied by the supplier. For example, a large supplier may have separate business units that each provide separate items. Separate contacts for each business unit are thus recorded in the system (e.g., separate contacts for a business unit that provides “investment castings” and “piping/valve” items). Thus, a user may select a commodity or subcommodity and have only the relevant suppliers and associated contacts retrieved and displayed. The system thereby ensures that users do not retrieve or list multiple entries for a given supplier at an auction.

The system may provide a Web page screen (not shown) that permits the user to place limitations on the level of participation for a specified supplier. For example, a buyer may elect to only open 40% of the buyer's volume to an unqualified supplier. Thus, the buyer may open a Supplier Limitations window to specify such limitations. The Supplier Limitations window may include the following fields: percent volume (an optional field to permit the user to specify the maximum percent volume for a supplier); Maximum Dollar Volume (an optional field for the user to input a numeric value corresponding to the maximum dollar amount volume for the user, with units equal to currency); and an Other field that allows the buyer to display notes to a specified supplier to specify any nonstandard type of limitations that might apply to the supplier. For example, the user may enter “supplier is limited to volume that can be produced in the qualified Shanghai manufacturing facility only; product from unqualified Zhuxi facility is not acceptable for this offering.” The supplier limitations note is specific to suppliers and may be provided as optional fields within the screen 700.

The system may automatically set flags and initiate counters in the supplier approval process. For example, the system may set a Supplier List Initiated flag corresponding to a date and time that the proposed supplier list is initiated (which may be used for span measurement). Likewise a Supplier List Completed flag identifies the date and time that the supplier list is amended up until when the RFQ is distributed or released to accepted suppliers (e.g., when the invite suppliers button 1422 is selected). After the RFQ is released, the last date before its release becomes a permanent entry for the Supplier List Completed flag, no longer changeable. A Supplier List Amended flag identifies each time the supplier list is amended. Unlike the Supplier List Completed flag, the Supplier List Amended flag will continue to update as supplier list changes are made until the auction closes. A Supplier List Completed counter increments each time the supplier list is changed before the RFQ is released. A Supplier List Amended increments each time the supplier list is changed after the RFQ is distributed, but before the auction closes.

The system automatically transmits documents to various members in the organization and to suppliers. For example, based on the country field 704, the system may automatically and electronically forward a courtesy copy to the appropriate pole representative for all electronic mail correspondence from or to the specified supplier in that representative's pole regarding an auction. In the depicted embodiment, all accepted suppliers receive the RFQ, auction details, cover letter and any attachments to the RFQ electronically. Such documents are stored electronically at a central location, such as on a Web server, to permit suppliers to access and retrieve such documents. Alternatively, the system may compress (and encrypt) such documents and transmit them electronically to the suppliers, rather than relying on suppliers to access a Web site for retrieving such documents. Under this alternative, the system may send individual messages to each accepted supplier without disclosing the identity or contact information for other suppliers invited to bid in the auction. Such information is distributed not only to suppliers but also to pole personnel (either directly, or posted to a Web server for retrieval by such pole personnel). The system may record the date, content and recipients of all transmissions on the system, and also record receipt dates of all responding transmissions (such as bids from suppliers). The system may collect all technical proposals and exceptions to the RFQ a user-defined number of days before the auction, send an e-mail to technical reviewers requesting that they review such proposals and exceptions, and post appropriate responses to either the individual supplier who submitted such proposals/exceptions or to a question and answer page, as appropriate. Further details regarding electronic distribution and transmission may be found in the U.S. Patent Applications noted above.

One skilled in the art will appreciate that the concepts of the above system can be used in various environments other than the Internet. For example, the concepts can also be used in an electronic mail environment where electronic mail messages may be used to create RFQs and provide information on auctions. Also, various communication channels may be used instead of the Internet, such as a local area network, wide area network, or a point-to-point dial-up connection. The server system may comprise any combination of hardware or software that can support these concepts. In particular, a Web server may actually include multiple computers. A client system may comprise any combination of hardware and software that interacts with the server system. The client systems may include television-based systems, Internet appliances and various other consumer products through which auctions may be conducted, such as wireless computers (palm-based, wearable, mobile phones, etc.). Moreover, the concepts of the present invention may be applied to auctions that are not supported by computer systems or that are only partially supported by computer systems.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, when used in this application, the words “herein,” “hereunder” and words of similar import shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other electronic commerce systems, not only to the RFQ and reverse auction system described above.

The elements and steps of the various embodiments described above can be combined to provide further embodiments. All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all electronic commerce systems that operate under the claims to provide a method for procurement. Accordingly, the scope of the invention is not limited by the disclosure, but instead is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I (We) claim:

1. In a public computer network connecting a buyer organization and at least first and second supplier computers associated respectively with first and second suppliers and each having a browser, wherein the first and second supplier computers are coupled to a set of one or more server computers associated with the buyer organization over the public computer network, a method comprising:
at at least one server computer in the set of server computers, providing a supplier selection electronic form, wherein the supplier selection electronic form includes a search and retrieve supplier record input field for retrieving from a database of supplier records, and add supplier input fields for receiving data for creating a new supplier record;
at at least one server computer in the set of server computers, receiving data input provided to the supplier selection electronic form, including input to the retrieve supplier record field to retrieve a first supplier record, and input to the add supplier input fields to create a second supplier record, wherein the first and second supplier records correspond to first and second suppliers proposed for inclusion in a new reverse auction to procure an identified item;
at at least one server computer in the set of server computers, electronically providing to individuals in the buyer organization a displayable document that provides notification of the new reverse auction and lists the first and second proposed suppliers for approval;
at at least one server computer in the set of server computers, receiving input from at least one individual in the buyer organization that the first and second suppliers are approved for participating in the new reverse auction; and
at at least one server computer in the set of server computers, electronically distributing new auction information to first and second supplier computers over the public computer network after receiving the approval.

2. The method of claim 1 wherein the public computer network is the World Wide Web, wherein the browser is a web browser,
wherein the supplier selection electronic form is a web page form stored in a central database coupled to at least one server computer in the set of server computers;
wherein the supplier selection electronic form includes a retrieve supplier record by supplier number input field and a retrieve supplier record by supplier name input field, and wherein the add supplier input fields include a supplier name field, geographic pole field, country field, contact name field, contact phone number field, contact email field, at least one supplier approval field, prior business experience field and at least one field for identifying items capable of being supplied;
wherein receiving input from at least one individual in the buyer organization includes receiving approval from an auction owner that the first and second suppliers are approved for participating in the new reverse auction, receiving approval from a geographic pole representative that the first and second suppliers have sufficiently completed a self assessment paper, and receiving approval from a quality assurance individual that the first and second suppliers executed secrecy or intellectual property protection agreements; and
wherein at least one server computer in the set of server computers employs logic to prohibit the first or second suppliers from participating in the new reverse auction if the approvals from the auction owner, pole representative and quality assurance individual are not received.

3. A system for facilitating procurement of an item under an auction from one of at least first and second suppliers, the system comprising:
at least one server computer, wherein the server computer is operable:
to provide at least one supplier selection electronic form, wherein the at least one supplier selection electronic form includes a retrieve supplier data input field for retrieving supplier data, and at least two add supplier input fields for receiving data regarding a new supplier;
to receive input data provided to the at least one supplier selection electronic form, including data input to either the retrieve supplier data field to retrieve first supplier data, or input to the add supplier input fields to add second supplier data, wherein the first supplier data and the second supplier data correspond respectively to the first and second suppliers, and wherein the received input data proposes the first or second supplier for inclusion in a new auction to procure an identified item; and
to electronically notify at least one individual of the first and second suppliers for approval to participate in the new auction, before conducting the new auction.

4. The system of claim 3 wherein a public computer network couples the server computer with at least a buyer computer, associated with a buyer organization, and at least first and second supplier computers, associated respectively with the first and second suppliers, and wherein the server computer includes a database coupled thereto, wherein the at least one supplier selection electronic form is a display description stored in the database, and wherein the database centrally stores supplier records for previously approved suppliers;
wherein the at least one supplier selection electronic form includes a retrieve supplier record by supplier number input field and a retrieve supplier record by supplier name input field, and wherein the add supplier input fields include at least two fields selected from a field set of: a supplier name field, geographic pole field, country field, contact name field, contact phone number field, contact email field, at least one supplier approval field, prior business experience field, and at least one field for identifying items capable of being supplied;
wherein the server computer is operable:
to receive input from an auction owner or buyer that at least one of the first and second suppliers are approved for participating in a new reverse auction, and receiving input and approval from a geographic pole representative that at least one of the first or second suppliers have sufficiently completed a self assessment or from a quality assurance individual that at least one of the first or second suppliers executed protection agreements; and
to electronically distribute new auction information to at least one of the first and second supplier computers over the public computer network after receiving the approval from the auction owner or buyer and the pole representative or quality assurance individual.

5. The system of claim 3 wherein the server computer is coupled to a database and the World Wide Web;
wherein the at least one supplier selection electronic form is a web page form stored in a central database coupled to the server computer;
wherein the retrieve supplier data field to retrieve first supplier data retrieves data regarding the first supplier, including at least one supplier approval field, prior business experience field or at least one field for identifying items capable of being supplied; and
wherein electronically notify at least one individual includes providing a Web page document that provides notification of a new reverse auction, lists the first and second proposed suppliers for approval, and provides approval input fields for at least an auction owner and a commodity expert.

6. The system of claim 3 wherein the at least one supplier selection electronic form includes a retrieve supplier record by supplier number input field and a retrieve supplier record by supplier name input field.

7. The system of claim 3 wherein the add supplier input fields include at least two fields selected from a field set of: a supplier name field, geographic pole field, country field, contact name field, contact phone number field, contact email field, at least one supplier approval field, prior business experience field, and at least one field for identifying items capable of being supplied.

8. The system of claim 3 wherein the server computer is further operable:
to receive input from an auction owner or buyer that at least one of the first and second suppliers are approved for participating in the new reverse auction, and receiving input and approval from a geographic pole representative that at least one of the first or second suppliers have sufficiently completed a self assessment or from a quality assurance individual that at least one of the first or second suppliers executed protection agreements.

9. The system of claim 3 wherein the server computer is operable:
to electronically distribute new auction information to at least one of the first and second supplier computers over the public computer network after receiving approval from an auction owner, buyer, geographic pole representative or quality assurance individual.

10. The system of claim 3 wherein electronically notify at least one individual includes providing a Web page document that provides notification of the new auction, lists the first and second proposed suppliers for approval, and provides approval input fields for at least an auction owner or a commodity expert.

11. The system of claim 3 wherein the retrieve supplier data field to retrieve first supplier data retrieves data regarding the first supplier, including at least one supplier approval field, prior business experience field or at least one field for identifying items capable of being supplied.

12. The system of claim 3 wherein electronically notifying includes sending first and second electronic mail messages to first and second individuals and storing at least one electronic document at a network location, wherein the electronic document may be accessed by a remote computer via a public computer network.

13. The system of claim 3 wherein electronically notifying includes sending at least one electronic mail messages to first and second individuals.

14. The system of claim 3 wherein the server computer is further operable to prohibit the first or second suppliers from participating in the reverse auction if the approval is not received.

15. The system of claim 3 wherein the server computer is further operable to provide automatic supplier approval after a select time period passes without receiving approval from the at least one individual.

16. A computer-readable medium whose contents cause a computer system to assist in procuring an item from one of at least first and second suppliers, by:
providing at least one supplier selection electronic form, wherein the at least one supplier selection electronic form includes a retrieve supplier data input field for retrieving supplier data, and at least two add supplier input fields for receiving data regarding a new supplier;
receiving information provided to the at least one supplier selection electronic form, including data input to either the retrieve supplier data field to retrieve first supplier data, or input to the add supplier input fields to add second supplier data, wherein the first supplier data and the second supplier data correspond respectively to the first and second suppliers, and wherein the received input data proposes the first or second supplier for inclusion in a new reverse auction to procure an identified item; and
before the auction, electronically notifying at least one individual of the first and second suppliers for approval to participate in the new auction.

17. The computer-readable medium of claim 16 wherein the at least one supplier selection electronic form includes a retrieve supplier record by supplier number input field and a retrieve supplier record by supplier name input field.

18. The computer-readable medium of claim 16 wherein the add supplier input fields include at least two fields selected from a field set of: a supplier name field, geographic pole field, country field, contact name field, contact phone number field, contact email field, at least one supplier approval field, prior business experience field, and at least one field for identifying items capable of being supplied.

19. The computer-readable medium of claim 16, further comprising receiving input from an auction owner or buyer that at least one of the first and second suppliers are approved for participating in the new reverse auction, and receiving input and approval from a geographic pole representative that at least one of the first or second suppliers have sufficiently completed a self assessment or from a quality assurance individual that at least one of the first or second suppliers executed protection agreements.

20. The computer-readable medium of claim 16, further comprising electronically distributing new auction information to at least one of the first and second supplier computers over the public computer network after receiving approval from an auction owner, buyer, geographic pole representative or quality assurance individual.

21. The computer-readable medium of claim 16 wherein electronically notify at least one individual includes providing a Web page document that provides notification of the new auction, lists the first and second proposed suppliers for approval, and provides approval input fields for at least an auction owner or a commodity expert.

22. The computer-readable medium of claim 16 wherein the retrieve supplier data field to retrieve first supplier data retrieves data regarding the first supplier, including at least one supplier approval field, prior business experience field or at least one field for identifying items capable of being supplied.

23. The computer-readable medium of claim 16 wherein electronically notifying includes sending at least one electronic mail messages to first and second individuals.

24. The computer-readable medium of claim 16 wherein the computer-readable medium is a logical node in a computer network receiving the contents.

25. The computer-readable medium of claim 16 wherein the computer-readable medium is a computer-readable disk.

26. The computer-readable medium of claim 16 wherein the computer-readable medium is a data transmission medium transmitting a generated data signal containing the contents.

27. The computer-readable medium of claim 16 wherein the computer-readable medium is a memory of a computer system.

28. A computer-readable medium containing a data structure having information for display and to assist in procuring an item from one of at least first and second suppliers under an auction, the information comprising:
a display description defining at least one supplier selection electronic form for identifying suppliers for participating in a new auction with respect to the item to procure, wherein the display description comprises at least first and second data input portions, wherein the first data input portion corresponds to a retrieve supplier data input portion for retrieving supplier data, and the second data input portion corresponds to at least two add supplier input portions for receiving data regarding a new supplier.

29. The computer-readable medium of claim 28 wherein the retrieve supplier data input portion includes a retrieve supplier record by supplier number input field and a retrieve supplier record by supplier name input field, and wherein the at least two add supplier input portions include at least two fields selected from a field set of: a supplier name field, geographic pole field, country field, contact name field, contact phone number field, contact email field, at least one supplier approval field, prior business experience field, and at least one field for identifying items capable of being supplied.

30. The computer-readable medium of claim 28 wherein the data structure includes instructions for the display of the information.

31. The computer-readable medium of claim 28 wherein the data structure represents a Web page.

32. The computer-readable medium of claim 28 wherein the data structure represents a document for display.

33. The computer-readable medium of claim 28 wherein the data structure is a data transmission medium transmitting a generated data signal containing the data structure.

34. A system to assist in procuring items from one of at least first and second suppliers, comprising:
means for providing at least one supplier selection electronic form, wherein the at least one supplier selection electronic form includes a retrieve supplier data input field for retrieving supplier data, and at least two add supplier input fields for receiving data regarding a new supplier;
means for receiving information provided to the at least one supplier selection electronic form, including data input to either the retrieve supplier data field to retrieve first supplier data, or input to the add supplier input fields to add second supplier data, wherein the first supplier data and the second supplier data correspond respectively to the first and second suppliers, and wherein the received input data proposes the first or second supplier for inclusion in a new reverse auction to procure an identified item; and
before the auction, means, coupled to the means for providing and the means for receiving, for electronically notifying at least one individual of the first and second suppliers for approval to participate in the new auction.

35. The system of claim 34, further comprising:
means for receiving input from an auction owner or buyer that at least one of the first and second suppliers are approved for participating in a new reverse auction, and receiving input and approval from a geographic pole representative that at least one of the first or second suppliers have sufficiently completed a self assessment or from a quality assurance individual that at least one of the first or second suppliers executed protection agreements; and
means for electronically distributing new auction information to at least one of the first and second supplier computers over the public computer network after receiving the approval from the auction owner or buyer and the pole representative or quality assurance individual.
